(19) United States
(12) Patent Application Publication
(10) Pub. No.: US 2024/0137772 A1
(43) Pub. Date: Apr. 25, 2024

(54) SYSTEMS AND METHODS FOR ADAPTIVE DATA SECURITY AND OPERATIONAL SECURITY CONTROLS OF MOBILE DEVICES

(71) Applicant: DISH Ukraine L.LC., Kharkiv (UA)

(72) Inventors: Zane Eaton, Pompano Beach, FL (US); Andrey Ilchenko, Kharkivs'ka Oblast (UA); Taras Stetsyuk, Cherkasko Lozova Village (UA)

(21) Appl. No.: 18/547,989

(22) PCT Filed: Feb. 26, 2021
(86) PCT No.: PCT/UA2021/000020

§ 371 Date: Aug. 24, 2023

(51) Int. Cl. H04W 12/63; H04W 12/37; H04W 12/40

(52) U.S. Cl. CPC H04W 12/63; H04W 12/37; H04W 12/40

(57) ABSTRACT

Systems, methods, and computer-readable media may facilitate adaptive control of operations of a mobile device. A communication received by a mobile device may be detected. A location of a mobile device associated with an identified individual may be determined. A protocol record stored in a memory device may be accessed, and rules specified by the protocol record may be identified, where an operational adjustment rule may be mapped to one or more locations and may include criteria for identifying operational adjustments. The criteria may be used to identify the operational adjustments at least partially as a function of the location of the mobile device. The operational adjustments may be caused in accordance with the operational adjustment rule. The operational adjustment may include controlling whether to render content objects on the mobile device in response to the mobile device receiving the communication and/or to perform preemptive operations.

### FIELD

Disclosed embodiments according to the present disclosure relate generally to mobile computing devices, and in particular to systems, methods, and computer-readable media for adaptive data security and operational security controls of mobile devices.

### BACKGROUND

Particularly in recent years, the unceasing increasing of communications—in number, frequency, types, and in more and more locations around the world—has caused various problems for data security. Data security needs can vary depending on varying locations, various events, various user devices, etc. One set of problems relates to confidential and/or sensitive information being presented on a screen a mobile device when the mobile device is in an insecure location. For example, notifications may be presented on a display of a mobile device, even though the mobile device may be in a locked state or is not being actively used by a user. The notifications may indicate the sender of the notification and/or content from the notification. With an incoming call, information, such as a name, number, and/or location associated with the caller, may be indicated on the screen of the mobile device. Any information presented on screen may risk unauthorized detection when a device is an insecure location. Conventional systems and devices are deficient in addressing changing needs and contexts that depend on a variety of factors. The lack of flexibility, speed, and device intelligence to address the changes compromises outcomes for systems and user devices.

Thus, there is a need to solve these problems and provide for systems, methods, and computer-readable media for adaptive data security and operational security controls of mobile devices. These and other needs are addressed by the present disclosure.

### BRIEF SUMMARY

Certain embodiments of the present disclosure relate generally to mobile computing devices, and in particular to systems, methods, and computer-readable media for adaptive data security and operational security controls of mobile devices.

In one aspect, a system to facilitate adaptive control of operations of a mobile device is disclosed. The system may include one or more processing devices and memory communicatively coupled with and readable by the one or more processing devices and having stored therein processor-readable instructions which, when executed by the one or more processing devices, cause the one or more processing devices to perform operations that may include one or a combination of the following. A communication received by a mobile device may be detected, the communication received via one or more networks. A location of a mobile device associated with an identified individual may be determined. A protocol record stored in a memory device may be accessed. A set of one or more rules specified by the protocol record may be identified, where at least one operational adjustment rule of the set of one or more rules may be mapped to one or more locations and may include criteria for identifying one or more operational adjustments from a plurality of operational adjustments. The criteria may be used to identify the one or more operational adjustments from the plurality of operational adjustments, where the one or more operational adjustments may be identified at least partially as a function of the location of the mobile device. Responsive to the detecting the communication, the one or more operational adjustments to the mobile device may be caused in accordance with the at least one operational adjustment rule. The one or more operational adjustments may include controlling whether to render one or more content objects on a screen of the mobile device in response to the mobile device receiving the communication and/or to perform one or more preemptive operations in response to the mobile device receiving the communication. The mobile device may consequently render the one or more content objects on the screen of the mobile device and/or performs the one or more preemptive operations.

In another aspect, a method to facilitate adaptive control of operations of a mobile device is disclosed. The method may include one or a combination of the following. One or more processing devices may detect a communication received by a mobile device, the communication received via one or more networks. The one or more processing devices may determine a location of a mobile device associated with an identified individual. The one or more processing devices may access a protocol record stored in a memory device. The one or more processing devices may identify a set of one or more rules specified by the protocol record, where at least one operational adjustment rule of the set of one or more rules may be mapped to one or more locations and may include criteria for identifying one or more operational adjustments from a plurality of operational adjustments. The one or more processing devices may use the criteria to identify the one or more operational adjustments from the plurality of operational adjustments, where the one or more operational adjustments may be identified at least partially as a function of the location of the mobile device. Responsive to the detecting the communication, the one or more processing devices may cause the one or more operational adjustments to the mobile device in accordance with the at least one operational adjustment rule. The one or more operational adjustments may include controlling whether to render one or more content objects on a screen of the mobile device in response to the mobile device receiving the communication and/or to perform one or more preemptive operations in response to the mobile device receiving the communication. The mobile device consequently may render the one or more content objects on the screen of the mobile device and/or performs the one or more preemptive operations.

In yet another aspect, one or more non-transitory, machine-readable media having machine-readable instructions thereon are disclosed, which instructions, when executed by one or more processing devices, may cause the one or more processing devices to perform one or a combination of the following operations. A communication received by a mobile device may be detected, the communication received via one or more networks. A location of a mobile device associated with an identified individual may be determined. A protocol record stored in a memory device may be accessed. A set of one or more rules specified by the protocol record may be identified, where at least one operational adjustment rule of the set of one or more rules may be mapped to one or more locations and may include criteria for identifying one or more operational adjustments from a plurality of operational adjustments. The criteria may be used to identify the one or more operational adjustments from the plurality of operational adjustments, where the one or more operational adjustments may be identified at least partially as a function of the location of the mobile device. Responsive to the detecting the communication, the one or more operational adjustments to the mobile device may be caused in accordance with the at least one operational adjustment rule. The one or more operational adjustments may include controlling whether to render one or more content objects on a screen of the mobile device in response to the mobile device receiving the communication and/or to perform one or more preemptive operations in response to the mobile device receiving the communication. The mobile device may consequently render the one or more content objects on the screen of the mobile device and/or performs the one or more preemptive operations.

In various embodiments of the above systems, method, and machine-readable media, a digital identifier corresponding to the communication may be detected, where the digital identifier may correspond to an entity specification mapped to the communication. Further, in various embodiments, the operational adjustment rule may be identified partially as a function of one or both of the digital identifier and the entity specification. In various embodiments, data received by the mobile device may be monitored. Based at least in part on the monitoring, the digital identifier corresponding to the communication may be detected. In various embodiments, a second set of one or more rules specified by the protocol record stored in the memory device may be accessed. The second set of one or more rules may include second criteria for recognizing entities. The second criteria may be used to analyze the digital identifier to map the digital identifier to the entity specification. In various embodiments, a set of observation data corresponding to one or more operations of the mobile device in one or more locations corresponding to the location may be collected. In various embodiments, a particularized pattern of operations of the mobile device may be determined based at least in part on analyzing the set of observation data to correlate the one or more operations of the mobile device, the one or more locations, and one or more corresponding times. The operational adjustment rule is learned by the one or more processing devices based at least in part on the particularized pattern of operations of the mobile device.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 depicts a high-level block diagram of a system, in accordance with embodiments according to the present disclosure.

FIG. 2 depicts is a block diagram of a system including one non-limiting example of an endpoint device that corresponds to a mobile communication device, in accordance with embodiments according to the present disclosure.

FIG. 3 illustrates a subsystem to facilitate adaptive control of operations of a mobile device, including adaptive data security and operational security controls, in accordance with embodiments according to the present disclosure.

FIG. 4 depicts a functional block diagram of certain aspects of adaptive data security and operational security control, in accordance with embodiments according to the present disclosure.

FIG. 5 illustrates a computer system, in accordance with embodiments according to the present disclosure.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment of the disclosure. It should be understood that various changes may be made in the function and arrangement of elements without departing from the spirit and scope of the disclosure as set forth in the appended claims.

Specific details are given in the following description to provide a thorough understanding of the embodiments. However, it will be understood by one of ordinary skill in the art that the embodiments maybe practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Various embodiments according to the present disclosure may provide for technological solutions to multiple problems existing with conventional systems, devices, and approaches. Conventional systems and devices are deficient in addressing changing needs and contexts that depend on a variety of factors. The lack of flexibility, speed, and device intelligence to address the changes compromises outcomes for systems and user devices. Various embodiments according to the present disclosure may provide for granular and adaptive data security solutions for mobile devices, where the solutions are at least partially a function of various locations, various communication sources, various events, the content of various communications, and/or the like.

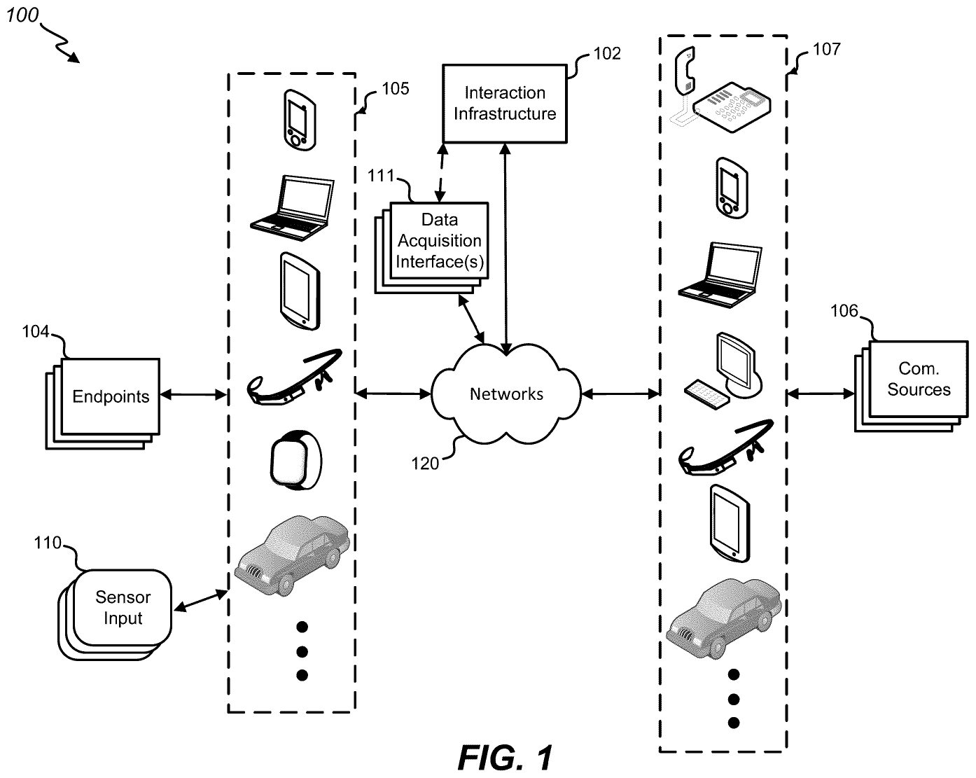

As disclosed herein, various embodiments may control the creation, presentation, and/or prevention of content objects for rendering on an endpoint device, using determined security of the current location of the endpoint device, the determined sensitivity of the content of the content objects, and/or the learned patterns of operational adjustments of the endpoint device. Various embodiments may selectively prevent confidential and/or sensitive information from being presented on a screen a mobile device when the mobile device is in an insecure location. This may include selectively preventing confidential and/or sensitive information from particular communication sources (but not from other communication sources) from being presented with notifications on a screen a mobile device, even though the mobile device may be in a locked state or is not being actively used by a user. This may further include selectively preventing incoming calls and corresponding notifications from particular communication sources (but not from other communication sources) when the mobile device is detected to be in an insecure location. Additionally or alternatively, various embodiments may provide for enhanced security modes for mobile devices such that, when potential unauthorized access is detected with respect to a particular mobile device, one or more operational adjustments to the mobile device may be caused to preempt or react to the detected potential unauthorized access. Still further, various embodiments may mitigate notification fatigue cause by too many notifications and may instead provide more intelligent and appropriate notification features. Various embodiments will now be discussed in greater detail with reference to the accompanying figures, beginning with FIG. 1.

FIG. 1 depicts a high-level block diagram of a system 100, in accordance with certain embodiments of the present disclosure. The system 100 may allow for interaction between two or more of an interaction infrastructure 102 (sometimes referenced herein as interaction system 102 or backend system), endpoint interfaces 105, communication source interfaces 107, data acquisition interfaces 111, and/or media channel interfaces 114. As depicted, components of the system 100 may be communicatively coupled or couplable to one or more networks 120.

In general, the system 100 may include one or more networks 120 that can be used for bi-directional communication paths for data transfer between components of system 100. Disclosed embodiments may transmit and receive data, including video content, via the networks 120 using any suitable protocol(s). The networks 120 may be or include one or more next-generation networks (e.g., 5G wireless networks and beyond). Further, the plurality of networks 120 may correspond to a hybrid network architecture with any number of terrestrial and/or non-terrestrial networks and/or network features, for example, cable, satellite, wireless/cellular, or Internet systems, or the like, utilizing various transport technologies and/or protocols, such as radio frequency (RF), optical, satellite, coaxial cable, Ethernet, cellular, twisted pair, other wired and wireless technologies, and the like. In various instances, the networks 120 may be implemented with, without limitation, satellite communication with a plurality of orbiting (e.g., geosynchronous) satellites, a variety of wireless network technologies such as 5G, 4G, LTE (Long-Term Evolution), 3G, GSM (Global System for Mobile Communications), another type of wireless network (e.g., a network operating under Bluetooth®, any of the Institute of Electrical and Electronics (IEEE) 802.11 suite of protocols, and/or any other wireless protocol), a wireless local area network (WLAN), a HAN (Home Area Network) network, another type of cellular network, the Internet, a wide area network (WAN), a local area network (LAN) such as one based on Ethernet, Token-Ring and/or the like, such as through etc., a gateway, and/or any other appropriate architecture or system that facilitates the wireless and/or hardwired packet-based communications of signals, data, and/or message in accordance with embodiments disclosed herein. In various embodiments, the networks 120 and its various components may be implemented using hardware, software, and communications media such wires, optical fibers, microwaves, radio waves, and other electromagnetic and/or optical carriers; and/or any combination of the foregoing and/or the like. In some embodiments, the networks 120 may include a telephone network that may be circuit switched, package switched, or partially circuit switched and partially package switched. For example, the telephone network may partially use the Internet to carry phone calls (e.g., through VoIP). In various instances, the networks 120 may transmit data using any suitable communication protocol(s), such as TCP/IP (Transmission Control Protocol/Internet protocol), SNA (systems network architecture), IPX (Internet packet exchange), UDP, AppleTalk, and/or the like.

As disclosed further herein, some embodiments of the interaction infrastructure 102 may facilitate searching of one or more information repositories in response to data received over the one or more networks 120 from any one or combination of the interfaces. In various embodiments, the interaction infrastructure 102 may include a set of devices configured to process, transform, encode, translate, send, receive, retrieve, detect, generate, compute, organize, categorize, qualify, store, display, present, handle, or use information and/or data suitable for the embodiments described herein. For example, servers of the infrastructure 102 may be used to store software programs and data. Software implementing the systems and methods described herein may be stored on storage media in the servers. Thus, the software may be run from the storage media in the servers. In some embodiment, software implementing the systems and methods described herein may be stored on storage media of other devices described herein. The interaction infrastructure 102 may be implemented in or with a distributed computing and/or cloud computing environment with a plurality of servers and cloud-implemented resources. The interaction infrastructure 102 may include processing resources communicatively coupled to storage media, random access memory (RAM), read-only memory (ROM), and/or other types of memory. The interaction infrastructure 102 may include various input and output (I/O) devices, network ports, and display devices.

According to certain embodiments, the interaction infrastructure 102 may include or provide a data and operational security control platform. A communication source 106 may cause communications to be sent to an endpoint interface 105 via a communication source interface 107 and the networks 120. An endpoint 104 may receive communications from the networks 120 via an endpoint interface 105. The interaction infrastructure 102 may facilitate searching of one or more information repositories in response to communications received and/or intercepted over the network 120 from the endpoint interfaces 105 and/or from communication source interfaces 107.

In some embodiments, endpoints 104 may use one or more endpoint interfaces 105; communication sources 106 may use one or more communication source interfaces 107. The endpoint interfaces 105 and/or communication source interfaces 107 may allow for transfer of and access to information in accordance with certain embodiments disclosed herein. In various embodiments, the client interface(s) 105 and/or communication source interface(s) 107 may include one or more suitable input/output modules and/or other system/devices operable to serve as an interface between client interface(s) 105 and the data and operational security control platform. The endpoint interfaces 105 and/or communication source interfaces 107 may facilitate communication over the network 120 using any suitable transmission protocol and/or standard. In various embodiments, the interaction infrastructure 102 may include, provide, and/or be configured for operation with the endpoint interfaces 105 and/or communication source interfaces 107, for example, by making available and/or communicating with one or more of a website, a web page, a web portal, a web application, a mobile application, enterprise software, and/or any suitable application software. In some embodiments, an endpoint interface 105 and/or communication source interface 107 may include an API to interact with the interaction infrastructure 102.

In some embodiments, an endpoint interface 105 and/or a communication source interface 107 may include a web interface. In some embodiments, the endpoint interface 105 and/or communication source interface 107 may include or work with an application made available to one or more interfaces, such as a mobile application as discussed herein. In some embodiments, the endpoint interface 105 and/or communication source interface 107 may cause a web page to be displayed on a browser of a service provider. The web page(s) may display output and receive input from a user (e.g., by using Web-based forms, via hyperlinks, electronic buttons, etc.). A variety of techniques can be used to create the web pages and/or display/receive information, such as JavaScript, Java applications or applets, dynamic HTML, and/or AJAX technologies. Accordingly, the interaction infrastructure 102 may have web site(s)/portal(s) giving access to such information, such as a provider portal.

In various embodiments, an endpoint interface 105 and/or a communication source interface 107 may include providing one or more display screen images that may each include one or more user interface elements. A user interface may include any text, image, and/or device that can be displayed on a display screen for providing information to a user and/or for receiving user input. A user interface may include one or more widgets, windows, dashboards, text, text boxes, text fields, tables, grids, charts, hyperlinks, buttons, lists, combo boxes, checkboxes, radio buttons, and/or the like.

In various embodiments, an endpoint interface 105 and/or a communication source interface 107 may include endpoint devices of an endpoint 104 and/or a communication source 106. In various embodiments, an endpoint interface 105 and/or a communication source interface 107 may correspond to a client computing device. An endpoint interface 105 and/or a communication source interface 107 may include a mobile computing device that may be any portable device suitable for sending and receiving information over a network in accordance with embodiments described herein. As in the illustrated embodiment, one or more endpoint devices may be used by endpoints 104 and communication sources 106 to interact via the one or more networks 120. Although only a limited number of the endpoint devices is shown, any number of endpoint devices may be supported. In various embodiments, the endpoint devices may correspond to devices supporting and/or accessing an endpoint interface 105 and/or a communication source interface 107. In some embodiments, the endpoint devices may correspond to devices supporting and/or accessing a data acquisition interface 111 and/or a media channel interface 114.

The endpoint devices may represent various computerized devices that may be configured to facilitate various adaptive data security and operational control features disclosed in various embodiments herein. In some embodiments, for example, an endpoint device 105 may include any type of television receiver (such as an STB (set-top box), for example) configured to decode signals received for output and presentation via a display device. In another example, the television receiver may be integrated as part of or into a television, a DVR, a computing device, such as a tablet computing device, or any other computing system or device, as well as variations thereof. In some embodiments, a television receiver may be a component that is added into the display device, such as in the form of an expansion card. In some embodiments, for example, an endpoint device 105 may include a laptop computer, a desktop computer, a home server, or another similar form of computerized device. As illustrated, the endpoint interfaces 105, 107 may, for example, correspond to a cellular phone, a laptop computer, a smartphone, a tablet computer, smart glasses, a smart watch, another type of wearable computerized device, a vehicle computer, and/or the like mobile devices. Further, as illustrated, an endpoint interface 107 may, for example, correspond to a wired telephone, a desktop computer, a smart speaker, and/or the like non-mobile devices. In various embodiments, the endpoint devices may be configured to operate a client application such as a web browser, a proprietary client application, a web-based application, an entity portal, a mobile application, a widget, or some other application, which may be used by a user of the endpoint device to interact with the interaction infrastructure 102 to use services provided by the interaction infrastructure 102. In various embodiments, the endpoint devices may be portable handheld devices (e.g., an iPhone®, cellular telephone, an iPad®, computing tablet, a personal digital assistant (PDA)) or wearable devices (e.g., Google Glass® device, a smart watch, and/or the like), running software such as Microsoft Windows Mobile®, and/or a variety of mobile operating systems such as iOS, Windows Phone, Android, BlackBerry®, Palm OS, and/or the like, and being Internet, e-mail, short message service (SMS), Blackberry®, and/or other communication protocol enabled. In some embodiments, one or more of the endpoint devices can be general purpose personal computers including, by way of example, personal computers and/or laptop computers running various versions of Microsoft Windows®, Apple Macintosh®, and/or Linux operating systems. In some embodiments, one or more of the endpoint devices can be workstation computers running any of a variety of available UNIX® or UNIX-like operating systems, including without limitation the variety of GNU/Linux operating systems, such as for example, Google Chrome OS. In some embodiments, one or more of the endpoint devices can be computing and communication devices integrated with or otherwise installed in a vehicle. Alternatively, or in addition, one or more of the endpoint devices may be any other electronic device, such as a thin-client computer, an Internet-enabled gaming system (e.g., a Microsoft Xbox gaming console with or without a gesture input device), and/or a personal messaging device, capable of communicating over network(s) 120.

In some embodiments, the interaction infrastructure 102 may be communicatively coupled or couplable to one or more data source systems via one or more data acquisition interfaces 111. The one or more data sources may include any suitable source of data to facilitate embodiments disclosed further herein. In various embodiments, the one or more data source systems may include one or more of a database, a website, any repository of data in any suitable form, and/or a third-party system. In various embodiments, the one or more data source systems may correspond to one or more social media websites and app services, microblogging websites and app services, and/or photo-sharing websites and app services. With some embodiments, the data source systems may include one or more mobile computing device locator services that provide information regarding the location of one or more endpoint devices 105, 107. In various instances, the data source systems may provide various details relating to IP addresses, cellular tower identification and location data, mobile device triangulation data, LAN identification data, Wi-Fi identification data, access point identification and location data, and/or the like data that facilitates location of one or more of the endpoint devices 105, 107. With some embodiments, the data sources may provide various details relating to call data, messaging data, and/or other communication data associated with phone calls, messages, and/or other communications sent from the endpoint devices 107 to the endpoint devices 105. With some embodiments, the data sources may provide caller name information from calling name delivery (CNAM), also known as caller identification or caller ID, may be used to determine particular details about the caller 106. With some embodiments, the data sources may provide information about the area of a caller 106. With some embodiments, the data sources may provide demographic data about an area.

In various embodiments, the data from the one or more data sources may be retrieved and/or received by the interaction infrastructure 102 via the one or more data acquisition interfaces 111 through network(s) 120 and/or through any other suitable means of transferring data. In some embodiments, the interaction infrastructure 102 and the data sources could use any suitable means for direct communication. According to certain embodiments, data may be actively gathered and/or pulled from one or more data sources, for example, by accessing a third-party repository and/or by “crawling” various repositories (e.g., databases, search engines, server systems, websites, file sharing sources, and/or the like). Certain data pulled and/or pushed from the one or more data sources may be transformed and the transformed data and/or other data generated based thereon may be made available by the interaction infrastructure 102 for users of endpoint devices. Data from the disparate data sources may be transformed from various different data formats into one or more formats compatible with one or more engines of the infrastructure 102. The transformation may further consolidating data from one or more data sources, filtering out redundant and/or irrelevant data from the incoming data sets, categorizing and classifying the filtered data, and/or adding metadata tags to the filtered data in accordance with the categorization/classification. In alternative embodiments, data from the one or more data sources may be made available directly to endpoint devices.

In some embodiments, the one or more data acquisition interfaces 111 may be implemented in similar manner to the interfaces 105 and/or 107 or any other suitable interface. In some embodiments, the one or more interfaces 105, 107 and/or data acquisition interfaces 111 may include one or more application programming interfaces (APIs) that define protocols and routines for interfacing with the data sources via the one or more network 120 or through any other suitable means for direct or indirect transmission of data and communications. The APIs may specify application programming interface (API) calls to/from data source systems. In some embodiments, the APIs may include a plug-in to integrate with an application of a data source system. The one or more interfaces 105, 107 and/or data acquisition interfaces 111, in some embodiments, could use a number of API translation profiles configured to allow interface with the one or more additional applications of the data sources to access data (e.g., a database or other data storage) of the data sources. The API translation profiles may translate the protocols and routines of the data source system to integrate at least temporarily with the system and allow communication with the system by way of API calls. Data, as referenced herein, may correspond to any one or combination of raw data, unstructured data, structured data, information, and/or content which may include media content, text, documents, files, instructions, code, executable files, images, video, audio, and/or any other suitable content suitable for embodiments of the present disclosure.

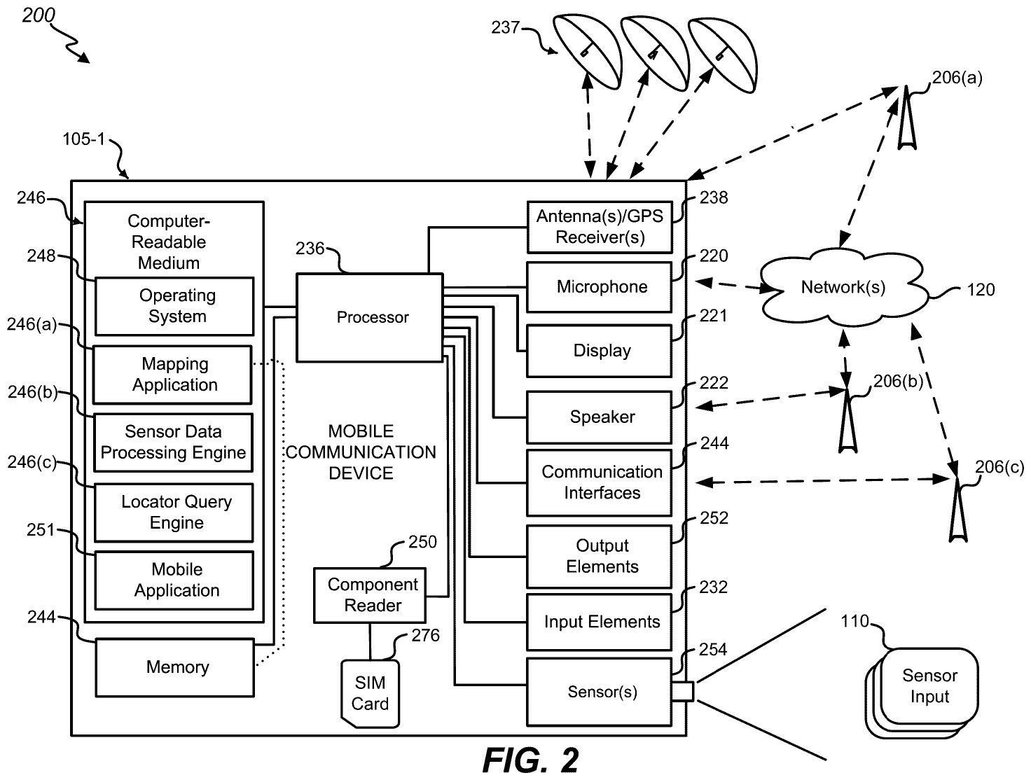

FIG. 2 is a block diagram of a system 200 including one non-limiting example of an endpoint device 105 that corresponds to a mobile communication device 105, in accordance with certain embodiments of the present disclosure. The mobile communication device 105 may be a portable device suitable for sending and receiving information over a network in accordance with embodiments described herein. For example without limitation, in various embodiments, the mobile communication device 105 may include one or more variously referenced as a mobile phone, a cellular telephone, a smartphone (for example without limitation, a smartphone such as: the iPhone® phone available from Apple Inc. of Cupertino, California; Android™ operating system-based phones, available from as Google of Mountain View, California; and/or the like), a handheld mobile device, a tablet computer, a web pad, a personal digital assistant (PDA), a notebook computer, a handheld computer, a laptop computer, a vehicle computer, smart glasses, other wearable computing devices, and/or the like.

In some embodiments, the mobile communication device 105 may be provided with a mobile application 251, which may correspond to a client application configured to run on the mobile communication device 105 to facilitate various embodiments of this disclosure. In various embodiments, the mobile application 251 can be any suitable computer program that can be installed and run on the mobile communication device 105, and, in some embodiments, the application 251 may not be a mobile app but may be another type of application, set of applications, and/or other executable code configured to facilitate embodiments disclosed herein. For example without limitation, the mobile application 251 may transform the mobile communication device 105 to facilitate and/or provide the data security and operational control features disclosed herein in accordance with various embodiments.

In various embodiments, the mobile communication device 105 configured with the mobile application 251 may provide one or more display screens that may each include one or more user interface elements. A user interface may include any text, image, and/or device that can be displayed on a display screen for providing information to a user and/or for receiving user input. A user interface may include one or more widgets, text, text boxes, text fields, tables, grids, charts, hyperlinks, buttons, lists, combo boxes, checkboxes, radio buttons, and/or the like. The mobile communication device 105 may include output elements 252. The mobile communication device 105 may, for example, include a display 221 and one or more speakers 222. The mobile communication device 105 may include input elements 232 to allow a user to input information into the mobile communication device 105. By way of example without limitation, the input elements 232 may include one or more of a keypad, a trackball, a touchscreen, a touchpad, a pointing device, a microphone and/or voice recognition device 220, other sensors 254, or any other appropriate mechanism for the user to provide input. Further, the input elements 232 may include a communication component reader 250 for accepting a communication component such as a SIM card 276.

In some embodiments, the endpoint device 105 may include one or more additional applications, for example, that may be provided by one or more intermediaries and/or may provide functionality relating to one or more intermediaries. An intermediary may be any entity, including, for example, a mapping service system, a geolocation service system, a traffic information service system, a news content system, a social networking system, a gaming system, a music service system, a multimedia content provider system, and/or the like. Content objects (e.g., media objects, multimedia objects, electronic content objects, and/or the like) of any of various types may be displayed through the one or more additional applications. The mobile application 251 and the mobile communication device 105 may cooperate with the interaction infrastructure 102 to facilitate endpoint and/or vehicle location tracking. In some embodiments, the mobile application 251 could include a toolkit with client-side utility for interfacing with the one or more additional applications to facilitate the tracking. In some embodiments, the one or more additional applications could include the toolkit. In some embodiments, the mobile application 251 could be grafted into the one or more additional applications to provide tracking and/or communication handling functionalities. In some embodiments, the mobile application 251 could use a number of API translation profiles configured to allow interface with the one or more additional applications.

The user selection of a user-selectable option corresponding to the mobile application 251 may involve any one or combination of various user inputs. The user selection may be in the form of a keyboard/keypad input, a touch pad input, a track ball input, a mouse input, a voice command, etc. For example, a notification and corresponding selectable interface option presented on the screen may be selected by the user by pointing and clicking on the notification and/or selectable option. As another example, a notification and corresponding selectable interface option presented on the screen may be selected by an appropriate tap, other touch, or movement applied to a touch screen or pad of the mobile communication device 105. The selection of the notification and corresponding selectable interface option presented on the screen may dismiss/close the notification, ignore the notification, send a corresponding call to voicemail, initiate a do-not-disturb mode, and/or provide user input corresponding to initiating an enhanced security mode and/or selecting any suitable parameter (e.g., for a protocol, adjustment rules 358, criteria, operational adjustments 382, etc.) for an enhanced security mode disclosed herein.

In some embodiments, the mobile application 251 can run continuously (e.g., in the background to monitor and report user locations and/or vehicle locations corresponding to the endpoints to the infrastructure 102) or at other times, such as when the mobile application 151 is launched by an endpoint or when a communication received by the communication device 105. The mobile application 251 may be provided in any suitable way. For non-limiting example, the mobile application 251 may be made available from the interaction infrastructure 102, a website, an application storage, etc. for download to the mobile communication device 105; alternatively, it may be pre-installed on the mobile communication device 105. In some embodiments, the mobile application 251 can be pre-installed on the device platform by a mobile communication device manufacturer or carrier. In some embodiments, a mobile application 251 can be downloaded and installed by an end user on their endpoint device 105.

The mobile communication device 105 may include memory 234 communicatively coupled to one or more processors 236 (e.g., a microprocessor) for processing the functions of the mobile communication device 105. The mobile communication device 105 may include at least one antenna 238 for wireless data transfer to communicate through a cellular network, a wireless provider network, and/or a mobile operator network, such as GSM, for example without limitation, to send and receive Short Message Service (SMS) messages or Unstructured Supplementary Service Data (USSD) messages. The mobile communication device 105 may also include a microphone 240 to allow a user to transmit voice communication through the mobile communication device 105, and a speaker 242 to allow the user to hear voice communication. The antenna 238 may include a cellular antenna (e.g., for sending and receiving cellular voice and data communication, such as through a network such as a 5G, LTE, 4G, etc. network). In addition, the mobile communication device 105 may include one or more interfaces in addition to the antenna 238, e.g., a wireless interface coupled to an antenna. The communications interfaces 244 can provide a near field communication interface (e.g., contactless interface, Bluetooth, optical interface, etc.) and/or wireless communications interfaces capable of communicating through a cellular network, such as GSM, or through Wi-Fi, such as with a wireless local area network (WLAN). Accordingly, the mobile communication device 105 may be capable of transmitting and receiving information wirelessly through both short range, radio frequency (RF) and cellular and Wi-Fi connections.

Additionally, the mobile communication device 105 can be capable of communicating with a Global Positioning System (GPS) 237 in order to determine to location of the mobile communication device 105. The antenna 238 may be a GPS receiver or otherwise include a GPS receiver. In various embodiments contemplated herein, communication with the mobile communication device 105 may be conducted with a single antenna configured for multiple purposes (e.g., cellular, transactions, GPS, etc.), or with further interfaces (e.g., three, four, or more separate interfaces). The mobile application 251 and the mobile communication device 105 may cooperate with the interaction infrastructure 102 to facilitate tracking and/or handling of endpoint locations.

The mobile communication device 105 may also include at least one computer-readable medium 246 coupled to the processor 236, which stores application programs and other computer code instructions for operating the device, such as an operating system (OS) 248. In some embodiments, the mobile application 251 may be stored in the memory 234 and/or computer-readable media 246. In some embodiments, the mobile application 251 may be stored on the SIM card 276. In some embodiments, mobile communication device 105 may have cryptographic capabilities to send encrypted communications and/or messages protected with message hash codes or authentication codes. Again, the example of mobile communication device 105 is non-limiting. Other devices, such as those addressed herein, may interact with the interaction infrastructure 102.

The mobile communication device 105 may access the network 120 through a wireless link to an access point. For example, a mobile communication device 105 may access the network 120 through one or more of access point 206(a), access point 206(b), access point 206(c), and/or any other suitable access point(s). The access points 206 may be of any suitable type or types. For example, an access point 206 may be a cellular base station, an access point for wireless local area network (e.g., a WiFi access point), an access point for wireless personal area network (e.g., a Bluetooth access point), etc. The access point 206 may connect the mobile communication device 105 to the network 120, which may include the Internet, an intranet, a local area network, a public switched telephone network (PSTN), private communication networks, etc. In some embodiments, access point(s) 206 may be used in obtaining location information for the mobile communication device 105.

In various embodiments, one or more sensors 254 may be integrated with the mobile communication device 105. A plurality of sensors 254 may include different types of sensors 254, each different type of sensor 254 configured to detect a different type of phenomena and/or generate a different type of data based on the detected phenomena. Thus, a multiplicity of integrated (and, in some embodiments, non-integrated) sensors 254 may be configured to capture phenomena at the mobile communication device 105 in order to identify aspects of an endpoint, other individuals, and/or the environment proximate to the endpoint, to facilitate any one or combination of facial recognition, optical recognition, infrared impressions, voice recognition, heat impressions, gestures, other endpoint movements, and/or the like. Data captured from such sensors 254 may be used in identification processes disclosed herein. For example, data from various types of sensors 254 may be used for recognizing image baselines (e.g., facial images of the endpoint to differentiate those from other individuals), sound baselines (e.g., voices of the endpoint to differentiate those from others proximate to the endpoint), activity baselines (e.g., changing locations and patterns thereof), and/or device operation baselines, as well as deviations from the baselines.

For example, the mobile computing device 236 may include an integrated camera 254, capable of capturing images and/or video, and a microphone and/or voice recognition device 220 capable of capturing voices and other audio. In some embodiments, the sensors 254 may include infrared sensors and/or heat sensors. In some embodiments, the camera(s) 254 may include one or more infrared cameras. The camera(s) 254 may, in some embodiments, include infrared sensors. In certain embodiments, the mobile computing device 236 may include a non-transitory computer-readable storage medium, e.g., memory 234, for storing sensor data captured with the sensors 254. With the sensors 254, the device 105 may capture proximate phenomena (which could be part of continuous, occasional, and/or device-initiated capture in various embodiments).

The computer-readable medium 246 can include a mapping application in some embodiments. In certain embodiments, the mapping application 246(a) can automatically run each time that a user accesses the mobile application 251 to facilitate surfacing of information regarding enhanced security modes and user-selectable interface options in accordance with location-based features disclosed herein. The computer-readable medium 246 can also include a sensor data-processing engine 246(b) that may be configured to process sensor data (e.g., video, audio, infrared, etc.) as disclosed further herein.

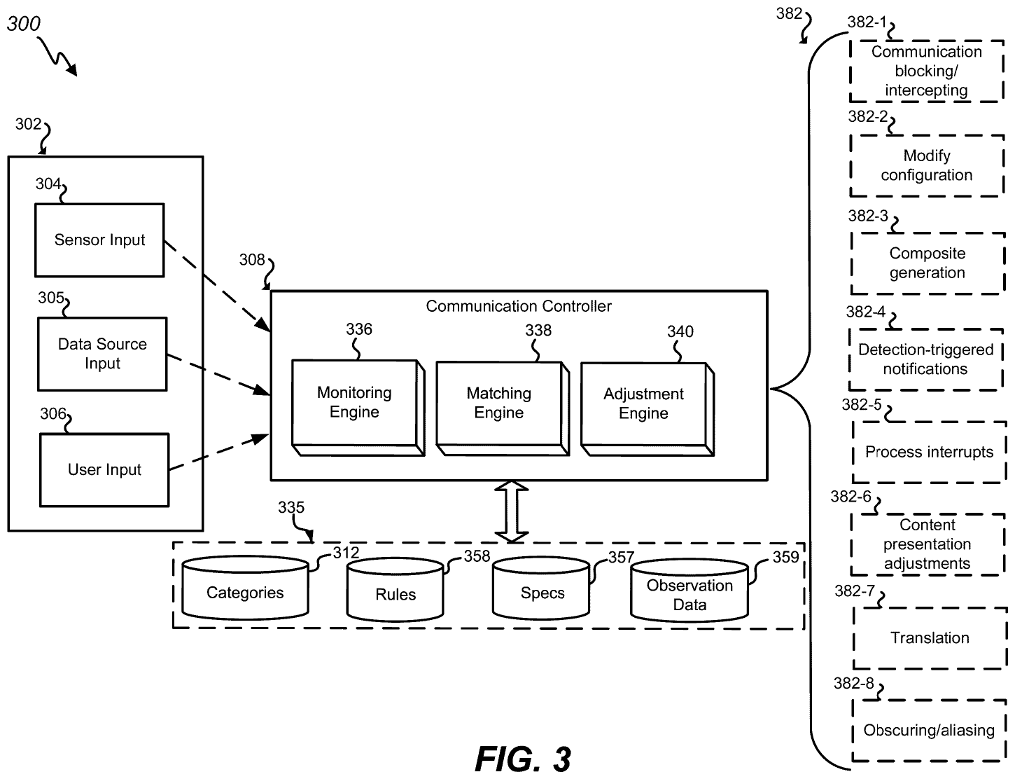

FIG. 3 illustrates a subsystem 300 to facilitate adaptive control of operations of a mobile device, including adaptive data security and operational security controls, in accordance with certain embodiments of the present disclosure. The subsystem 300 may correspond to aspects of the system 100. While the subsystem 300 is illustrated as being composed of multiple components, it should be understood that the subsystem 300 may be broken into a greater number of components or collapsed into fewer components. Each component may include any one or combination of computerized hardware, software, and/or firmware.

In some embodiments implementing the subsystem 300 at least partially with the interaction infrastructure 102, the subsystem 300 may be, correspond to, and/or include one or more servers that, in various embodiments, may include one or more switches and/or media gateways, such as telephone, messaging, email, application, and/or other types of gateways. The subsystem 300 may be configured to determine which communications (e.g., calls) from communication sources 106 go to which devices 105. The subsystem 300 may include one or more network interfaces, one or more processors and memory. In various embodiments, one or more of the processor(s), memory, and/or network interface(s) may correspond to the endpoint device 105 and/or one or more servers of the infrastructure system 102. The network interface(s) may include any suitable input/output module or other system/device operable to serve as an interface between one or more components of the endpoint device 105 and/or the system 102 and the one or more networks 120. The network interfaces may be used to communicate over the networks 120 using any suitable transmission protocol and/or standard. The one or more network interfaces may be configured to facilitate communications between endpoint interfaces 105 and 107, which communications may, for example, correspond to calls and/or notifications/messages from set of callers/senders and a set of receivers, respectively.

In some embodiments, the subsystem 300 may include one or more adaptive processing and controlling devices 308 (which may be referenced as “communication controller” and/or “communication control engine”) and one or more storage repositories 335. In various embodiments, the endpoint device 105 and/or the interaction infrastructure 102 may include the one or more adaptive processing and controlling devices 308 and one or more storage repositories 335 in whole or in part. Accordingly, in some embodiments, the endpoint device 105 may be configured to provide the features of the one or more adaptive processing and controlling devices 308 and one or more storage repositories 335. For example, the application 251, a plug-in, and/or other code installed and executed by the endpoint device 105 may transform the mobile communication device 105 to facilitate and/or provide the data security and operational control features disclosed herein in accordance with various embodiments.

In some embodiments, the interaction infrastructure 102 may be configured to provide the features, and, in various embodiments, the endpoint device 105 and the interaction infrastructure 102 may cooperate to provide the features, with aspects of the subsystem 300 (e.g., operations and features of the one or more adaptive processing and controlling devices 308 and one or more storage repositories 335) distributed between the endpoint device 105 and the remotely-located interaction infrastructure 102, which may be in the cloud. The one or more repositories 335 may be implemented in various ways. In various embodiments, the one or more repositories 335 may correspond to the memory 244 and/or other storage of the mobile device 105, one or more relational or object-oriented databases, flat files on one or more computers or networked storage devices, a centralized system, a distributed/cloud system, network-based system, such as being implemented with a peer-to-peer network, or Internet. In various embodiments, the categories repositories 312 may store any suitable data to facilitate any categorization, correlation, qualification, scoring, and/or the like disclosed herein in any suitable manner. In various embodiments, the rules repositories 358 may store any suitable data to facilitate any rules, protocols, criteria, process flows, and/or the like disclosed herein in any suitable manner. In various embodiments, the specification repositories 358 may store any suitable data to facilitate any endpoint specifications, endpoint profiles, device profile, communication source profiles, and/or the like disclosed herein in any suitable manner. In various embodiments, the observation data repositories 359 may store any suitable data to facilitate any observation data, patterns, conclusions, inferences, sensor data, reference sensor data, and/or the like disclosed herein in any suitable manner. Although the repositories are depicted as being separate, in various embodiments, a single repository 335 may be utilized or separate repositories may be used in any suitable manner.

In various embodiments, the one or more adaptive processing and controlling devices 308 may include one or more of engines and/or modules that may be stored in the one or more memories and may include one or more software applications, executable with the processors, for receiving and processing requests and communications. The one or more of engines and/or other modules may be configured to perform any of the steps of methods described in the present disclosure. The one or more engines of the communication controller 308 may include one or more routing engine(s) that may include logic to implement and/or otherwise facilitate any communication handling features discussed herein. By way of example without limitation, the routing engine may be configured to one or more of decode, route, and/or redirect calls from devices 107 directed to a device 105. The subsystem 300 may make real-time decisions in order to improve end-user adaptation and data security. Accordingly, certain embodiments may provide real-time, dynamic routing as an endpoint-adaptive solution. In some embodiments, the routing engine may be separate from the communication controller 308. The communication controller 308 may be configured to receive inbound calls from callers, determine caller data pertinent to the calls, perform information analysis of the caller data, gather additional caller data as needed, and match callers to protocol records. Accordingly, the communication controller 308 may be or include a call handling engine in some embodiments. In some embodiments, the communication controller 308 may include a message handling engine to provide message handling features disclosed herein.

As disclosed herein, embodiments according to the present disclosure provide technological solutions to multiple problems existing with conventional systems, devices, and approaches. In various embodiments, the subsystem 300 may be configured to allow for adaptively and intelligently routing communications from devices 107 directed to a device 105 and for recognizing and learning communications in real time or near real time. In some embodiments, the one or more processing devices of the endpoint device 105 may be configured to provide a communication control engine 308 and may accordingly provide the features of the one or more adaptive processing and controlling devices 308 disclosed herein. The subsystem 300 may include may include logic to implement and/or otherwise facilitate any communication handling features disclosed herein. By way of example without limitation, the subsystem 300 may include one or more call handling modules that may be configured to one or more of decode, route, and/or redirect calls from devices 107 directed to a device 105. Similarly, the subsystem 300 may include one or more message/notification handling modules that may include logic to implement and/or otherwise facilitate any message/notification handling features disclosed herein. While systems, engines, repositories, and other components are described separately herein, it should be appreciated that the components may be combined and/or implemented differently in any combination to provide certain features in various embodiments. In various embodiments, different processes running on one or more shared computers may implement some of the components.

In some embodiments, the subsystem 300 includes the communication control engine 308, which may be referenced herein as a communication controller and may executed by one or more processors of the endpoint device 105 and/or the infrastructure system 102 in various embodiments. The communication control engine 308 may be communicatively coupled with interface components and communication channels (which may take various forms in various embodiments as disclosed herein) configured to receive adjustment input 302. As depicted, the adjustment input 302 may include sensor input 304, data source input 305, and user input 306. The subsystem 300 may process the adjustment input 302 and analyze the adjustment input 302 to provide for adaptive data security and operational control features disclosed herein. The data source input 305 may correspond to data captured via the one or more data acquisition interfaces 111. The data source input 305 may correspond to data from one or more data source systems, as disclosed herein. The user input 306 may correspond to selections and other input provided by an endpoint 104 via interface elements of the endpoint device 105, as disclosed herein.

Disclosed embodiments may provide for identification, learning, and recognition of how to handle incoming communications (e.g., calls and notifications) as a function of the sources 106 of the communications, as a function of the current geolocation of the mobile device 105, and/or as a function of phenomena detected at the device 105. The communication control engine 308 may include a monitoring engine 336 configured to monitor the adjustment input 302. The control engine 308 may include a matching engine 338 that may be an analysis engine configured to determine any suitable aspects pertaining to aspects of the endpoint device 105, the endpoint 104, communications received by the device 105, communications sent by the devices 107 and sources 106, phenomena proximate to the device 105, and locations of the device 105 based at least in part on adjustment input 302 received and processed by the monitoring engine 336. The matching engine 338 may correspond to a learning engine that includes logic to implement and/or otherwise facilitate any taxonomy, classification, categorization, correlation, mapping, qualification, scoring, organization, and/or the like features disclosed herein. In various embodiments, the matching engine 338 may be configured to analyze, classify, categorize, characterize, tag, and/or annotate sensor-based data. The matching engine 338 may employ one or more artificial intelligence (machine learning or, more specifically, deep learning) algorithms to perform pattern matching to detect patterns of metrics of the sensor-based data. In some embodiments, the monitoring engine 336 and/or the matching engine 338 may facilitate one or more learning/training modes disclosed herein. Accordingly, the learning engine may facilitate machine learning or, more specifically, deep learning, to facilitate creation, development, and/or use of endpoint pattern data. The subsystem 300 may adapt to particular endpoints 104 based at least in part on the matching engine 338 learning particularized patterns of operations of the mobile device 105 from observation data collected by the subsystem 300.

The control engine 308 may include an adjustment engine 340 configured to cause the one or more adjustments 382 disclosed herein. In some embodiments, the adjustment engine 340 may analyze input monitored by the monitoring engine 336, determinations of the matching engine 338, and/or information stored in one or more repositories 335 to make adjustment 382 determinations. Based at least in part on one or more adjustment 382 determinations, the adjustment engine 340 may cause activation of one or more adjustment 382 actions. The control engine 308 may transmit one or more signals to one or more processors 236 and/or one or more applications of the device 105 to cause the one or more operations adjustments disclosed herein.

The sensor input 304 may correspond to sensor input 110 and may be captured by the sensors 254. As disclosed herein, the sensor input 304 may include sensor data from the sensors 254 and may correspond to detected phenomena. In various embodiments, the sensor input 304 may include video data and/or other types of sensor data (e.g., heat/IR, etc.) may be analyzed to recognize patterns and thereby establish baselines with respect to the endpoint device 105 and to further identify deviations with respect to the endpoint device 105. For example, video data may be analyzed to recognize the particular endpoint 104 and to further identify deviations with respect to the recognized endpoint 104. When facial recognition is used to authenticate an endpoint 104 via one authentication stage, subsequent stages of authentication may be implemented to confirm that there are no deviations detected with respect to the recognized endpoint 104, such recognition of another individual (other than the recognized endpoint) and recognition of the other individual's gaze directed toward the device 105. As another example, video and/or other types of sensor data (e.g., heat/IR, etc.) may be analyzed to recognize the general form of an endpoint 104. With such patterns created, subsequent stages of authentication may be implemented to confirm no deviations from the recognized general endpoint form, which may be distinguished from ambient forms (e.g., forms of others and objects in the background). Such deviations may correspond to another individual gazing toward the device 105, otherwise facing the device 105, and/or in the proximity of the device 105. Such deviations may correspond to types of movements, such as an endpoint moving away from an endpoint device (e.g., leaving the proximate area about the endpoint device 105, moving out of a range of a sensor, etc.), a changed endpoint such that a different endpoint is detected at the endpoint device, and/or the like. Accordingly, some deviations may correspond to the detection of multiple endpoints at the single endpoint device 105. For example, while the initially authenticated endpoint 104 may be detected as continuing access via the endpoint device 105, an additional endpoint may also be detected. Such deviations may increase subsystem 300 qualification (e.g., security scoring, alert levels, and/or the like) of the security of the device 105 to varying extents, based on which, the subsystem 300 may cause one or more operational adjustments 382, prohibit access via the endpoint device 105, and/or to otherwise cause notification of the deviations (which may depend on the security score and score thresholds in some embodiments).

Similarly, audio data may be analyzed to recognize audio patterns and thereby establish audio baselines with respect to the endpoint device and to further identify deviations with respect to the endpoint device. The matching engine 338 may include an audio analyzer and handling module to facilitate audio recognition. By way of example, the matching engine 338 may detect one or more audio characteristics by way of any one or combination of analyzing audio, applying voice recognition, acoustic spectrum analysis, comparison to acoustic profiles for contacts/individuals, and/or the like. The audio pattern analysis may identify tonal, pitch, and volume characteristics; keywords and corresponding language used; cadence, pauses, and accents; ambient noise; and/or the like as distinctive markings and could compile the audio pattern characteristics for the purposes of endpoint characterization. When such audio pattern recognition is used as at least part of one authentication stage, subsequent stages of authentication may be implemented to confirm no deviations from the audio pattern with respect to one or more of the audio characteristics of the audio pattern. Again, one deviation may correspond to a changed endpoint such that one or more different endpoints are detected at the endpoint device via audio detection of one or more different voices proximate to the device 105 (i.e., one or more voices that are system-recognized as being different from the voice of the authenticated user of the device 105, that is, the endpoint 104). The different endpoint may or may not be recognized, but the lack of correspondence to the previously detected audio pattern may be determined with the one or more subsequent stages of authentication. Thus, audio recognition may be used with subsequent stages of authentication to recognize audio patterns and detect deviations therefrom, alter scores, and then cause one or more operational adjustments 382, prohibit access via the endpoint device 105, and/or to otherwise cause notification of the deviations.

Some embodiments may authenticate not only the endpoint 106 but also other individuals and may perform operational adjustments 382 as a function of the voice recognition of the other individuals. For example, the endpoint device 105 may store a list of contacts/individuals that may be voice-recognized. In some embodiments, the endpoint 106 may create and modify the list of individuals that the subsystem 300 is to voice-recognize, monitor for, and authenticate for operational adjustments 382 that the subsystem 300 may make when at least one of the individuals is voice-recognized as being proximate to the endpoint device 105 based at least in part on the sensor input 304. In some embodiments, the application 251 may provide interface elements for an interactive list of individuals that are to be voice-recognized, monitored for, and authenticated for operational adjustments 382 that the subsystem 300 may make when at least one of the individuals is voice-recognized as being proximate to the endpoint device 105 based at least in part on the sensor input 304. Each individual/contact may be mapped to one or more protocol records that specify one or more operational adjustments 382 that are to be automatically made when the voice of the individual/contact is recognized from the audio phenomenon detected at the device 105. Various operational adjustments 382 are disclosed further herein and may include, for example, temporarily terminating/preventing notifications from one or more email accounts until the voice of the individual/contact is not sensed at the device 105 for a predetermined period of time.

In some embodiments, the subsystem 300 may receive and process sensor data 104 to obtain sufficient one or more voice samples of speech that can be synthesized to learn the voice impressions mapped to the contacts stored in the device 105 and/or in other devices associated with the endpoint 106. In some embodiments, such learning may be initiated by default and may be performed using voice communications from the particular contacts. For instance, the subsystem 300 may learn the voice impression of a particular contact when the individual mapped to the stored contact information calls the endpoint device 105. The subsystem 300 may analyze the voice data of the phone call, create a voice impression/profile for the contact, and store the voice impression/profile for subsequent voice-identification of the individual. The subsequent voice-identification of the individual may be performed with subsequent phone calls from the individual (e.g., to further learn and refine the voice impression/profile for the contact) and may be performed to identify subsequent instances where the individual is physically proximate to the endpoint device 105.

As disclosed herein, the data source input 305 may correspond to data from one or more data source systems. The data source input 305 may correspond to any suitable data from any suitable data source system to facilitate various embodiments disclosed herein. For example, with data source input 305, the subsystem 300 (e.g., the endpoint device 105) may identify a source 106 of a call or notification, details regarding the source 106, call, and/or notification, information regarding the area in which the device 105 is currently located, and/or the like. The one or more data source systems may include any suitable source of data to facilitate embodiments disclosed further herein. In some embodiments, the subsystem 300 may be communicatively coupled or couplable to one or more data source systems corresponding to remote systems via one or more data acquisition interfaces 111. The data source input 305 may be received via the one or more data acquisition interfaces 111. In various embodiments, the one or more data source systems may include one or more of a database, a website, any repository of data in any suitable form. In various embodiments, the one or more data sources may correspond to one or more social media websites and/or photo-sharing websites. With some embodiments, the data source systems may include one or more mobile computing device locator services that provide information regarding the location of one or more endpoint devices 106. With some embodiments, the data source systems may provide various details relating to call data. With some embodiments, the data source systems may provide caller name information from calling name delivery (CNAM), also known as caller identification or caller ID, may be used to determine particular details about the caller. With some embodiments, the data source systems may provide information about the area of in which the device 105 is detected as being currently located. With some embodiments, the data source systems may provide demographic data about the area, such one or more languages commonly spoken in the area.

One deviation with respect to the recognized endpoint 104 may correspond to an additional endpoint such that a different endpoint is detected at the endpoint device. The different endpoint may or may not be recognized, but the lack of correspondence to the previously authenticated endpoint may be determined. For example, the subsystem 300 may recognize when one or more other individuals (i.e., other than the authenticated endpoint 104) are facing the screen of the endpoint device 105. The subsystem 300 may recognize such a situation with the one or more individuals potentially corresponding to one or more screen spies. When the subsystem 300 has determined that the endpoint device 105 is in a particular location (e.g., one corresponding to an insecure location), the subsystem 300 may access a stored protocol record associated the endpoint 104 and/or endpoint device 105 and may identify one or more rules 358 specified by the protocol record, where at least one operational adjustment rule of the set of one or more rules 358 is mapped to one or more locations and comprises criteria for identifying one or more operational adjustments 382 from a plurality of operational adjustments 382. The subsystem 300 may use the criteria to identify the one or more operational adjustments 382 from the plurality of operational adjustments 382, where the one or more operational adjustments 382 are identified is at least partially as a function of the location of the endpoint device 105.

Responsive to the detecting the deviations (e.g., detecting a potential screen spy), the subsystem 300 may cause the one or more operational adjustments 382 to the device 105 in accordance with the at least one operational adjustment rule. In various embodiments, operational adjustments 382 to the device 105 may include changing operational settings of the device 105. In some embodiments, this may include the application 251 and/or one or more other components of the subsystem 300 instructing another application of the device 105 to change its operational settings. In various embodiments, the adjusted state of the endpoint device 105 according the operational adjustments 382 may be maintained for a predetermined time (e.g., a number of seconds), only while the deviation (e.g., potential screen spy) is detected, only while the device 105 is detected as being in an insecure area, or until an interface element is selected (e.g., endpoint selection to clear the notification and/or modification), after which the endpoint device 105 may be returned to its previous state.

The operational adjustments 382 may include blocking and/or intercepting 382-1 communications. In various embodiments, operational adjustments 382 to the device 105 may cause the device 105 to block calls, messages, and/or notifications and vibrational responses to calls and/or messages from particular sources 106. In various embodiments, operational adjustments 382 disclosed herein may be prevent notifications from being presented by the device 105. It should be understood that such prevented notifications may in various embodiments include textual/graphical notifications presented on a screen of the device 105, vibrational notifications causing the device 105 to vibrate, and/or audio notifications audially presented by the device 105 (e.g., an audio message such as “incoming call from Jane Doe”). Thus, for example, such communications, notifications, and responses may be blocked when the device 105 is detected as entering or having entered a particular area (e.g., an insecure area or other designated area). In some embodiments, the blocking of communications and responses may be effected by way of the application 251 temporarily adjusting the notification and response settings of the device 105. In some embodiments, the blocking of communications and responses may be effected by way of the application 251 and/or other components of the subsystem 300 intercepting the communications while the enhanced security mode is in effect (e.g., while the device 105 is detected as being in an insecure location), as disclosed further herein.

One operational adjustment may include causing the mobile device 105 to activate a do-not-disturb mode. However, such a mode may be unnecessary or undesirable to an endpoint 104, whereas targeted shunting and/or other preemptive operations may be preferred. Moreover, despite an activated do-not-disturb mode, visual, audible, and/or tactile notifications may nonetheless be effected responsive to certain types of communications from certain sources 106. For example, when a contact is identified as a favorite on the mobile device 105, calls and messages may still be presented with visual, audible, and/or tactile notifications on the device 105. Likewise, for example, when certain email senders are identified by an email application as important, a notification responsive to an email from such a sender may still be presented on the screen of the mobile device 105. In some instances, such notifications may present content regarding the email, such as sender name, subject, message content, time received, etc. The presentation of such potentially confidential content may be effected initially with the initial presentation of a visual notification, in some instances. In some instances, the presentation of such potentially confidential content may be effected responsive to device-detected stimulus, such as the smartphone being raised or otherwise moved, an individual touching the screen or a button on the phone, or the endpoint 104 looking at the screen with the phone recognizing the face of the user with facial identification. Such presentation of potentially confidential content may be effected even while the screen is locked.

Additionally or alternatively, the operational adjustments 382 may include modifying the configurations of one or more applications 382-2. In some embodiments, the application 251 may be configured to adjust the notification settings of one or more other applications on the device 105 in order to effect one or more of the operational adjustments 382 in accordance with one or more operational adjustment rules 358. For example, the application 251 may be configured to change the settings of a settings application on a mobile phone 105, to activate/deactivate a do-not-disturb mode, to adjust notification settings globally of the entire device 105, to adjust notification settings of particular applications on the mobile phone 105 either directly or via the settings application, and/or the like. The adjustment of notifications settings may include allowing/disallowing notifications globally, allowing/disallowing notifications of particular applications, allowing/disallowing sounds, badges, and/or content previews, allowing/disallowing alerts on lock screens or otherwise, and/or the like. Accordingly, the operational adjustments 382 may be dependent on a type of application and may be effected on per-app and per-source 106 bases. Thus, the operational adjustments 382 may include disabling or disallowing notifications for a time period as a function of the particular application and the particular source 106. Disclosed embodiments may be configured to monitor for communications, identify particular sources 106 of communications received/intercepted, and disable and prevent notifications of the communications which would otherwise be triggered in particular applications by the communications. Various embodiments may intercept the communications and/or corresponding notifications in application layer and/or presentation layer of the device 105 and prevent corresponding notifications from being presented. Various embodiments may intercept the communications to the applications (in some embodiments, prior to the applications receiving signals corresponding to the communications) in application layer and/or presentation layer of the device 105 and prevent corresponding notifications from being presented. Further, some embodiments may also present substitute notifications (e.g., synopsis notifications, alias notifications, obscured notifications, and/or the like) as disclosed herein.

In some embodiments, the application 251 may spin up an agent to monitor for particular communications from particular sources 106 and/or particular notifications responsive to communications. In some embodiments, the subsystem 300 may include an agent engine 118C that may instantiate an agent to identify types of the particular communications and/or particular notifications. The agent engine 118C may be configured to initiate agents configured to detect the particular communications and/or particular notifications, and, in various embodiments, the agents may be specific to communication type, source entity, and/or any other suitable characteristic. The agent may, in various embodiments, correspond to a bot, a listener, and/or the like, and may conform ITI-41, HL7 v.2, HL7 v.3, C-CDA, NEMSIS, FHIR, XDs.b, XDR, or any suitable protocols. In some embodiments, the application 251 (e.g., by way of the agent in some embodiments) may intercept communications directed to the mobile device 105 from the device 106, such that, in particular security modes, the mobile device 105 is prevented from presenting notifications responsive to communications from particular or all devices 107 and communication sources 106. In various embodiments, the application 251 (e.g., by way of the agent in some embodiments) may preempt or react to the reception of particular communication from a particular source 106 by disabling notifications for an application (e.g., phone app, email app, messaging app, social media app, etc.) corresponding to the communication. Additionally or alternatively, having identified specifications of the device operational configurations at the outset of the enhanced security mode, only those applications of the device 105 that have one or more notification settings allowed need be monitored (e.g., by the application 251) when the device 105 is in the enhanced security mode. Accordingly, certain embodiments may provide for concentrated device security where the adaptive granularities of the operational adjustments 382 are on per-application, per-communication, and/or per-source bases.

Further, operational adjustments 382 may include communication composite generation 382-3. During the pendency of the enhanced security mode, the application 251 and/or other components of the subsystem 300 may monitor the blocked communications for indicia of urgency. When a plurality of communications from the same source 106 are blocked over a particular period, the number of communications may be determined to meet a threshold number. Additionally or alternatively, keyword recognition of messages and voicemails may be performed to recognize keywords that are indicia of urgency. For example, when, say, 8 communications are received from a particular 106 over a 30-minute period and/or when keywords such as “emergency” are recognized, a synopsis notification may be created and presented on the locked screen of the device 105 with or without a haptic vibration alert. The synopsis notification may correspond to a content composite based at least in part on content from two or more of the communications. The synopsis notification may include an indicator of the recognized urgency (e.g., content indicating the number of communications received from the source 106 over the time period and/or indicating one or more keywords from the communications). The synopsis notification may further include a graphically obscured version of the contact name and/or phone number, or may use a pseudonym/alias for the contact name and/or phone number.

In some embodiments, the subsystem 300 may recognize one or more keywords and/or expressions from communications (e.g., oral communications detected, email, messages, other notifications) that the matching engine 338 may for the purposes of characterizing the communication. The matching engine 338 may correlate the one or more keywords and/or expressions to one or more dialogue categories 312 for similar impressions. In various embodiments, the correlation may be based at least in part on matching selected keywords and/or expressions to identical and/or similar keywords and/or expressions specified for certain categories 312. The categories 312 may include categorizations of concept, keyword, expression, and/or the like. Based at least in part on the communication impression, the matching engine 338 may create a profile for the communications and associated source 106. The profile may be retained in any suitable form, such as a file, a list, etc. and may be stored in the repository 357.

Additionally or alternatively, the operational adjustments 382 may include notifications 382-4 regarding detected deviations from baselines. In various embodiments, operational adjustments 382 to the device 105 may cause the device 105 to present one or more notifications on a display of the device 105 when a deviation (e.g., one mapped to a potential screen spy) is detected. The one or more notifications may indicate the detection of the deviation in any suitable manner with graphics, text, audio, and/or vibration.

Additionally or alternatively, the operational adjustments 382 may include process interrupts 382-5. For example, in some embodiments, a notification may be presented with a modal window and/or the like pop-up that requires endpoint interaction with an interface element in order to dismiss the notification and continue viewing or interacting with other interface elements. Thus, the operational adjustments 382 may include causing activation and presentation of modal windows and/or the like.

Additionally or alternatively, the operational adjustments 382 may include content presentation adjustments 382-6. Additionally or alternatively, one or more windows that were active and/or presented on the display of the device 105 may be minimized or closed when a deviation is detected. Thus, the operational adjustments 382 may include causing minimization and/or closing of windows, frames, and/or the like. Additionally or alternatively, content that is presented on the display of the device 105 when a deviation is detected may be decreased in size (e.g., by decreasing font size, decreasing the size of the window/frame presenting the content, zooming out from the current display of the content on the application actively presenting the content, and/or the like). Thus, the operational adjustments 382 may include causing content to become smaller when a deviation is detected.

Additionally or alternatively, the operational adjustments 382 may include notification content translation 382-7. For example, content that is presented on the display of the device 105 (e.g., by way of an application and/or notification when the screen is unlocked or when the screen is locked) when a deviation is detected may be translated to a different language and presented in the different language. Likewise, additionally or alternatively, content that is presented on the display of the device 105 when the device is detected as being in an insecure area may be translated to a different language and presented in the different language. The subsystem 300 may learn which languages the endpoint 104 uses orally and/or with the endpoint device 105. For example, if the subsystem 300 learns that the endpoint 104 uses the endpoint device 105 with settings and content in a first language (e.g., English) and additionally speaks and/or uses the endpoint device 105 with settings and content in a second language (e.g., German), the operational adjustment may cause the content that is presented on the display of the device 105 when a deviation is detected to be translated from the first language to the second language and presented in the second language. In some embodiments, such an operational adjustment may only be caused when the detected location of the endpoint device 105 is mapped to one or more official and/or commonly used languages that are different from the second language. Thus, with the above example, when the detected location of the device 105 is in Germany (or another location where German is commonly spoken or is detected by the subsystem 105 as being spoken in proximity of the device 105 based on voice and language recognition features disclosed herein), the translation from English to German would be prevented. In such a case, the subsystem 300 would be configured to translate to a third language if applicable and not spoken in the location, or cause one or more other operational adjustments 382 disclosed herein.

Additionally or alternatively, the operational adjustments 382 may include notification obscuring/aliasing 382-8. For example, content that is presented on the display of the device 105 (e.g., by way of an application and/or notification when the screen is locked) when a deviation is detected may be scrubbed, obscured, and/or altered. For example, in various embodiments, although a notification regarding a call from a particular source 106 may normally identify a contact name and/or a phone number of the particular source 106, the contact name and/or phone number may be removed, graphically obscured, or replaced with a pseudonym/alias. In embodiments employing pseudonym/alias features, the same pseudonym/alias may be consistently used for communications from the same source 106. The subsystem 300 may automatically select and assign a pseudonym/alias to a particular source 106, however the subsystem-selected name may be overridden and altered by the endpoint 104 so that the endpoint-specified name is used for the pseudonym/alias for the particular source 104. Likewise, in various embodiments, although a notification regarding a message from a particular source 106 may normally include a portion of the message as a preview of the message on the locked screen, the portion may be removed, graphically obscured, or replaced with boilerplate text, which may be subsystem-selected by default and optionally endpoint-specified.

In some embodiments, the operational adjustment rules 358 may provide for device settings verification operations. For example, responsive to the subsystem 300 (e.g., the application 251) detecting a security event that triggers a heightened security mode, the verification operations may include verifying the current state of device operational configuration of the device 105. This may include determining which notification settings are enabled on the device 105. If, for example, the application 251 determines that all notifications are disabled for applications (e.g., phone, messaging, email, and other applications) on the device 105, then the application 251 need not cause any operational adjustments 382 to the device 105. However, in other more likely cases, the verification operations may include storing (e.g., by way of the application 251) in memory specifications of the current state of the device operational configurations (e.g., listings of applications, notification settings, and associated flag values indicating the settings) to facilitate subsequent return of the device 105 to its previous operational configuration when the device 105 is detected as having transitioned out of the heightened security area and/or condition (e.g., due to the device 105 changing locations, due to an unauthorized individual no longer being detected, and/or due to endpoint input overriding the heightened security mode). Thus, when the device 105 is detected as having transitioned out of the heightened security area and/or the insecure condition is no longer detected for a threshold time (or responsive to endpoint interface element input directing the termination of the enhanced security mode and/or operational adjustments 382), the verification operations may include, either comparing the current state of the device operational configurations to the previous operational configuration then adjusting any changed settings back to the previous setting, or reversing/undoing any otherwise tracked settings adjustments (which may be tracked in any suitable manner) to the previous settings. Accordingly, with the termination of the enhanced security mode, the operational configuration of the device 105 may be returned to its previous state that was in effect prior to most recent activation of the enhanced security mode.

Various embodiments may employ hierarchical operational adjustment chaining, which, in some embodiments, may be implemented with decision trees. For example, in one set of one or more adjustment chains, one or more operational adjustments 382 corresponding to the communication/notification blocking features disclosed herein may be caused when the device 105 is detected as being in an insecure area, then one or more operational adjustments 382 corresponding to the notifications/alterations to the presented content (e.g., screen spy protection features disclosed herein) may be caused when one or more deviations with respect to the recognized endpoint 104 are detected (e.g., correlated to detection of a screen spy). In another example set of one or more adjustment chains, one or more operational adjustments 382 corresponding to the notifications/alterations to the presented content (e.g., the language translation features) may be caused when the device 105 is detected as being in an insecure area or when one or more deviations with respect to the recognized endpoint 104 are detected. However, if conditions for the language translation features (e.g., no additional language used by the endpoint 104 has been determined, or all endpoint-used languages are spoken in the location) are not satisfied, then one or more operational adjustments 382 corresponding to the communication/notification blocking features disclosed and/or other content alteration features (e.g., scrubbing, obscuring, minimizing, etc.) disclosed herein may be caused. In yet another example set of one or more adjustment chains, one or more operational adjustments 382 corresponding to the communication/notification blocking features disclosed herein (e.g., complete blocking, translating, scrubbing, obscuring, etc.) may be caused when the device 105 is detected as being in an insecure area or deviations are detected, then the or more operational adjustments 382 corresponding to the urgency recognition features (e.g., synopsis and/or haptic vibration) may be caused when urgent conditions are determined to be satisfied. In still another example set of one or more adjustment chains, a first screen spy protection adjustment (e.g., a notification), then, if the notification is not cleared within a time limit (e.g., a number of seconds) via endpoint selection of an interface element and the deviation condition continues and is still detected, one or more additional adjustments (e.g., window/frame minimization, content size decreasing, modal windows, language translation) may be caused.

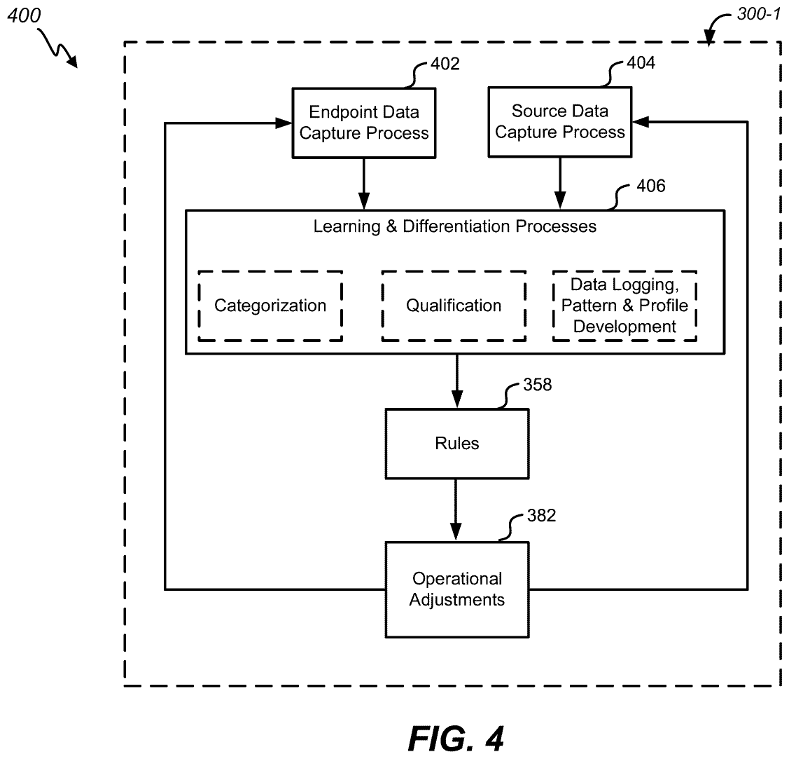

FIG. 4 depicts a functional block diagram of certain aspects of adaptive data security and operational security control 400, in accordance with certain embodiments of the present disclosure. Various embodiments may employ any one or combination of various methods of adaptive data security and operational security control. The subsystem 300 may be configured to perform one or a combination of the aspects of adaptive data security and operational security control 400 in various embodiments. As disclosed herein, operations corresponding to the aspects of adaptive data security and operational security control 400 may be performed in whole or in part by the infrastructure system 102 and/or the endpoint device 105 in various embodiments. Accordingly, the operations may be performed cooperatively by the system 102 and the device 105, or may be performed wholly by either the system 102 or the device 105 (e.g., with application 251 installed on the device 105) in various embodiments.

As indicated by block 402, one or more endpoint data capture processes may be performed. The endpoint data capture processes may include capturing one or a combination of the adjustment input 302. Thus, the endpoint data capture processes may capture data at the endpoint device 105, such as sensor data 304 corresponding to detected phenomena at the device 105, data source systems input 305, and user input 306. Likewise, as indicated by block 404, one or more source data capture processes may be performed. Such data capture processes may be ongoing to facilitate ongoing machine-learning processes by the subsystem 300. Captured data may include any suitable data that may be captured to identify communications from particular sources 106 directed to particular endpoints 104 and devices 105 and to indicate, infer, determine, and/or learn how to adapt operational controls with respect to the devices 105 and communications from the particular sources 106. Additionally or alternatively, captured data may include any suitable data that may be captured to identify patterns and baselines (and deviations therefrom) of phenomena at the device 105 and of endpoint operations of the device 105, and to indicate, infer, determine, and/or learn how to adapt operational controls with respect to the devices 105 based at least in part on the detected patterns, baselines, and deviations.

The subsystem 300 may receive and process endpoint data and source data in implementing the data capture processes. As indicated by block 406, with captured endpoint data and source data, the subsystem 300 may implement learning and differentiation processes. The subsystem 300 may collect a set of observation data corresponding to one or more operations of the mobile device 105 in one or more locations corresponding to one or more locations.

The matching engine 338 may qualify the observation data and may, for example, score the observation data based at least in part on categories. The matching engine 338 may include logic to implement and/or otherwise facilitate any qualification features disclosed herein. In certain embodiments, the matching engine 338 may be configured to compile keyword criteria, for example, in an ontology. The matching engine 338 could include an ontology reasoner or semantic reasoning module to make logical inferences from a set of facts in the ontology. Accordingly, the matching engine 338 may correspond to a reasoning engine configured to effect one or more communication source qualification features. A pattern-based reasoner could be employed to use various statistical techniques in analyzing the observation data in order to make inferences based on the analysis. A transitive reasoner could be employed to infer relationships from a set of relationships related to the observation data. The subsystem 300 may determine a particularized pattern of operations of the mobile device 105 based at least in part on analyzing the set of observation data to correlate the one or more operations of the mobile device, the one or more locations, and one or more corresponding times.

For example, the matching engine 338 may learn particular user-initiated operations in particular locations and from particular communication sources 106. The user-initiated operations may include selecting one or more communications source-specific interface options as disclosed further herein, selecting a do-not-disturb option of device 105, clearing particular notifications on the locked screen of the device 105 (e.g., finger swiping to clear a notification regarding a call or message from a particular communication sources 106 presented on the screen of the device 105), and/or the like. There may be times when it would be beneficial to change how particular applications on a mobile device 105 operate based at least in part on a detected geolocation of the mobile device 105. Phone applications, for example, often give notifications that are both visual (e.g., notifications presented on the screen of the device responsive to calls received, messages received, push notifications, and other notifications received) and audible (e.g., ring tones, alerts, and vibrations). Such notifications can present problems for the endpoint 104 when such notifications are not disabled (e.g., because of time constraints, other constraints, forgetfulness, or simply not thinking of it) when the device 105 is in an insecure location or another location for which such notifications are inappropriate and/or undesirable. For instance, an endpoint 104 may want to ensure that his mobile device 105 does not receive or does not present visual, audible, or tactile notifications responsive to communications (e.g., phone calls, text messages, email notifications, and other notifications which would typically be received via one or more apps on the device 105 and cause user-detectable notifications in response) from a particular source 106, while the mobile device 105 is at a particular location (e.g., a particular house, building, restaurant, etc.). Accordingly, the subsystem 300 may learn particular user-initiated operations in particular locations and from particular communication sources 106 and consequently create, develop, and store a protocol record that specifies one or more rules 358.

As disclosed herein, the subsystem 300 may learn specifications of attributes of the contacts of the endpoint 104 and map appropriate operational adjustments 382 as a function of the environment of the endpoint device 105 and the learned specifications of the contacts. The system 100 may harvest, aggregate, and consolidate observation data regarding the contacts. This may include receiving and storing user input 306, which may be provided by way of selection of interface elements to specify attributes of contacts and to associate operational adjustments 382 with the contacts. This may further include collecting data source input 305 from the device 105 and from one or more data source systems via the one or more data acquisition interfaces 111. As disclosed herein, data may be actively gathered and/or pulled from one or more data sources, for example, by accessing a repository and/or by “crawling” various repositories. In some embodiments, an observation data gathering utility of the subsystem 300 (e.g., of the application 251 in some embodiments) may include features for identifying observation data of the endpoint 104 and the contacts thereof. The data collection may include not just gathering contact information specifically saved in an address book or directory on the device 105 but also recognition of contact information in communications (e.g., in email, text messages, at messages, and/or the like) and collecting contact information in a remote address book and or directory associated with the device 105 (e.g., a work directory linked to, and accessible by, the endpoint device 105). The observation data may include user indications of preference of entities and subject matter, such as positive ratings, indication of liking an entity, sharing entity-specific and/or subject-matter-specific information with others that the user has made via webpages and/or social media. The interest indicia gathering utility may include features for automatically identifying contacts of the endpoint 104 based at least in part on one or more other accounts of the endpoint 104. An account could be linked (e.g., via API) to the one or more other accounts, including an account associated with online social/provider networking services (which may include microblogging/short messaging services), an email account, and/or any other suitable data source. In some cases, an endpoint 104 could be prompted to login to the other account(s) to allow for the harvesting. In some cases, previously provided authentication information stored by the device 105 may be used so that logging in is not necessary to enable the harvest. Indicia of interests of contacts could be identified by approval/disapproval indicators, which may be in form of likes, dislikes, thumbs-up, thumbs-down, star-scale ratings, number-scale ratings, fan indications, affinity group association, messages to providers, and/or the like. The approval/disapproval indicators could be those associated with the contacts' profiles.

In one example, the endpoint device 105 may have installed on it an application directed to sports. According to normal operational settings of the application and the device 105, updates regarding game scores for particular sports team may be received by the device 105 and presented on a locked screen of the device 105. However, the subsystem 300 may determine based at least in part on the observation data collected from one or more of the data source systems (e.g., a social media system) that one particular contact (e.g., a friend) likely has a strong aversion to a particular sports team. The aversion may be inferred from negative indicia (e.g., dislikes of the particular team on a social media profile of the contact) and/or positive indicia (e.g., likes of another team that is a determined rival of the particular team), and, in some instances) recent games (i.e., wins/losses) of the two teams. Such subsystem conclusions may be stored in a profile record associated with the contact, along with a voice profile of the contact and specifications of rules 358 for operational adjustments 382 as a function of detecting the contact in physical proximity to the endpoint device 105. When the contact is voice-recognized as being physically proximate to the device 105, the protocol rules 358 and specifications of operational adjustments 382 may be accessed by the device 105 (e.g., application 251). The operational adjustments 382 may include intercepting any notifications, performing content recognition of the notifications to determine whether they relate to the particular team disliked by the contact (e.g., updates regarding scores), and, upon a determination of a particular notification relates to the particular team, preventing the notification from being presented on the device 105 while the contact is voice-recognized as being proximate to the device 105 and for a predetermined time after the last instance of detection of the contact as being physically proximate to the device 105. Thus, while the contact is detected as physically proximate to the device 105, the subsystem 300 may recognize the current location of the device 105 as an insecure location for notifications containing content that the subsystem 300 determines is related to the particular team to which the subsystem 300 determined the contact has a strong aversion.

In some instances, a particular current location of the device 105 may be an insecure environment (which may be referenced herein as insecure location and/or sensitive location), such as a particular workplace, house, reports, airplanes, any public place or other place where there are potentially unauthorized individuals, and/or the like. The subsystem 300 may recognize notifications as not being appropriately matched for the location based at least in part on the source 106 of the communication that would otherwise cause the notification and/or the content of the notification and/or the communication. Thus, for example, when the current location corresponds to a work context, notifications from work and client contacts may be allowed to be presented, but certain other communications and notifications may not be appropriate for the work context and may, therefore, be prevented. Many other examples are possible. Further, the user may not want to receive any such notifications while the mobile device 105 is within a particular distance (e.g., 5 miles) of the particular location. The subsystem 300 may (e.g., by way of one or more application on the device 105) monitor constantly, periodically, or occasionally the current locations of the device 105 to ensure that the device 105 does not receive or does not present user-detectable notifications while the device 105 at the particular location or within the particular distance of the location. In some instances, the particular location may become an insecure location and/or sensitive location when the subsystem 300 detects one or more other unauthorized individuals (other than the authenticated endpoint 104) by image recognition, audio recognition, and/or the like as disclosed herein. Accordingly, the subsystem 300 may detect that the device 105 is in an insecure environment, which the subsystem 300 may determine as a function of a number of factors that may include location, detected individuals in proximity to the device 105, and/or the like disclosed herein.

In some instances, the subsystem 300 may automatically create a protocol record mapped to the endpoint 105. Additionally or alternatively, the endpoint 105 may create a protocol record to be stored by the subsystem 300. The subsystem 300 may store the protocol record in the specifications repository 358. The protocol record may include specifications of one or more locations. In some embodiments, the subsystem 300 may create a list of particular locations mapped to the endpoint device 105 based at least in part on collecting observation data that includes location data corresponding to detected locations of the endpoint device 105 and learning, by the learning engine, patterns of locations and corresponding device operations at those locations. The subsystem 300 may cause presentation of the system identified locations via an interface 105 in order to elicit endpoint confirmation, modification, or rejection of the system-identified locations.

In various embodiments, the endpoint 105 may provide user input 306 to create, confirm, modify, and/or reject a list of particular locations, which may correspond to a list of user-specified locations. Such user input 306 may be provided by way of user selections of interface elements and/or input into input entry fields provided by way of one or more applications of the endpoint device 105 (e.g., a mapping application 246(a), a locator query engine 246(c), and/or another application 251). For example, a mobile application may be made available for execution on the mobile computing device 105 that may include a specific purpose-based mobile application or a mobile application integrated with various other mobile application features. The mobile application executed on a mobile computing device 105 may provide for displaying a map interface and/or a list interface with interface elements for user selection and marking of locations. The interface may further provide for displaying on a map and/or a list, indicators of locations of the device 105, which may include previously user-specified locations, as well as past locations of the device 105 where the subsystem 300 has detected that the device 105 has spent significant time. For example, if the device 105 has been detected by the subsystem 300 as having stayed in a particular location for at least a threshold amount of time (e.g., a number of minutes, hours, etc.) and/or as having frequented a particular location for at least a threshold number of times for a given time period (e.g., twice a day, or any suitable frequency), the particular past location may be indicated via the interface.

For one or more of the particular locations, the subsystem 300 may further automatically specify a distance from the particular location, which distance could be selected by default or learned by the learning engine based at least in part on the collected observation data. Again, such system-determined specifications may be presented via the interface 105 for endpoint confirmation, rejection, and/or modification. In various embodiments, the endpoint 104 may additionally confirm, modify, and/or otherwise specify a distance from the particular location. For example, this may include selecting interface elements to drag, draw, or otherwise indicate an area about the location. Additionally, the subsystem 300 may define the proximal area for the device 105 based at least in part on observation data that the subsystem 300 has collected with respect to the device 105 and/or the endpoint 104, such as past locations and user selections of proximal areas with respect to user-specified locations. The area proximal to the location may have any of various suitable forms. The proximal area may be a circular area with a particular radius with the location as the origin. Thus, for example, the endpoint 104 may select interface elements to drag, draw, or otherwise indicate circle about the particular location to correspond to a border that is a particular distance from the location. However, the proximal area may not be circular but could be defined by any shape. The shape of a search area may be irregular. The form of the proximal area may be more tailored to the specific observations of the device 105 and/or the endpoint 104 in some embodiments, e.g., by taking into consideration a device's direction of travel and/or an endpoint's previous communications/selections. In some embodiments, the more information that is known about a particular endpoint 104, the more irregular and/or form-fitted a proximal area may be in shape. As such, where little is known about an end-user, the shape may be a simple circle, rectangle, triangle, etc. However, if there is a rich data set of interactions with the endpoint 104, the subsystem 300 may more accurately infer the proximal areas for detected locations of the device 105.

In some embodiments, the subsystem 300 may automatically specify insecure and/or sensitive locations to be defined at least in part by when the endpoint device 105 is detected to be proximate to one or more other endpoint devices. Accordingly, the events and conditions corresponding to the endpoint device 105 coming into proximity with the one or more other endpoint devices may allow for the identification of dynamic insecure and/or sensitive locations that change as a function of the proximity of the device 105 with the one or more endpoint devices. Again, such automatically created specifications may be presented for endpoint confirmation, modification, and/or rejection via the interface 105. Additionally or alternatively, such specifications may be created per user input 306 via the interface 105. The subsystem 300 likewise may identify proximal areas as disclosed herein. The proximal area may thus be a changing, relative area that depends on being proximate to another device and may encompass instances where, for example, the multiple devices, including the device 105, are moving/traveling together or in close proximity.

In various embodiments, the locations and identifiers of the one or more other devices may be detected by the subsystem 300 by way of data source systems that may provide data relating to IP addresses, cellular tower identification and location data, mobile device triangulation data, LAN identification data, Wi-Fi identification data, access point identification and location data, and/or the like data that facilitates location of the one or more other devices. Additionally or alternatively, the locations and identifiers of the one or more other devices may be detected by the subsystem 300 by way of communications of the one or more other devices and/or the device 105 with the infrastructure system 102. Additionally or alternatively, the locations and identifiers of the one or more other devices may be detected by the subsystem 300 by way of communications between the one or more other devices in the device 105. In some embodiments, the endpoint 104 may identify the one or more other devices via the interface 105 (e.g., by way of any suitable digital identifier, such as a phone number, contact name, device identifier, and/or the like). In some embodiments, the subsystem 300 may include, or access data from data source systems that use, Automatic Number Identification (ANI) logic and Caller Name Service (CNS) to identify callers.

In some embodiments, the system 102 may track the locations of the one or more additional devices. In some embodiments, the device 105 may detect proximity of the one or more other devices by way of any suitable receiver to receive signals from one or more signal sources and/or electronic communications. This may include transmitting electronic communications to the one or more other devices. The electronic communications may be transmitted, for example, upon detecting a new type of signal (e.g., detecting a presence of another device); at regular times or intervals; upon receiving a request; and/or upon detecting that a transmission condition has been satisfied. The electronic communications may include (for example) one or a combination of prompts to accept and facilitate device pairing, requests for device identifier information, prompts to accept and facilitate device location tracking, links to communicate with the backend system 102 to facilitate device location tracking, transfers of one or more codes, tokens, partial keys, barcodes, and/or other evidence of authentication to/from one or more of the device 105 and the other devices, and/or the like. The electronic communications may be transmitted, for example, over a wireless network, WiFi network, short-range network, Bluetooth network, Near Field Communication (NFC), local area network, ZigBee, Z-Wave, RF, and/or the like. Each of the device 105 and the one or more other devices may include communication modules and interfaces 244 that may include any one or combination of ZigBee, Bluetooth, Z-Wave, Wi-Fi, and/or the like RF communication modules which allow the wireless communication of proximate devices. In various embodiments, the device information sharing may be effected by a “bump” transfer which may be a cloud-based or NFC-based transfer responsive to two devices being physically against each, a text, or a call. However, in some embodiments, the locations of the one or more other devices may be detected without cooperation of one or more other devices.

For each of the particular locations, the subsystem 300 may automatically specify a set of one or more operations (operational adjustments 382) that the subsystem 300 (e.g., by way of the one or more applications on the device 105) should take under one or more conditions and/or consequent to one or more events. Again, such system-specified operations may be presented for endpoint confirmation, modification, and/or rejection via the interface 105. Additionally or alternatively, the endpoint 104 may specify a set of one or more operations that the subsystem 300 should take under one or more conditions and/or consequent to one or more events. For example, one event may correspond to the endpoint device 105 being detected, by way of the subsystem 308 monitoring the current locations of the endpoint device 105, as crossing the border defining the proximal area for the location and entering into the proximal area. Accordingly, one example condition may correspond to when the location of the device 105 is detected as being within the proximal area. An example operation specified through the interface elements could correspond to blocking phone number X when entering the proximal area or blocking all communications from contact Y when entering the proximal area. Additional operations are disclosed herein. Another event may correspond to the endpoint device 105 being detected as crossing the border defining the proximal area and exiting from the proximal area. Accordingly, another condition may correspond to when the location of the device 105 is detected as being outside the proximal area. For such events and conditions, an example operation specified through the interface elements could correspond to unblocking phone number X when entering the proximal area or unblocking all communications from contact Y when entering the proximal area.

The subsystem 300 may transform the specifications of operations and conditions and/or events into a set of rules 358. In various embodiments, the subsystem 300 may develop the protocol record that is mapped to the endpoint 104 to link to, reference, hyperlink, point, and/or include the set of rules 358. As disclosed herein, the protocol record may be stored in the specifications repository 358 in some embodiments. In some embodiments, the set of rules 358 may be stored separately, for example, in the rules repository 358. In some embodiments, the rules 358 may be executable by one or more processing devices of the subsystem 300 (e.g., by one or more processing devices of the device 105 and/or the system 102 in various embodiments as disclosed herein). The rules 358 may include criteria for identifying operational adjustment rules 358 from a plurality of operational adjustment rules 358 mapped to locations. Thus, for example, the location of the mobile device 105 may be continuously, periodically, or occasionally as disclosed herein, and, when the device 105 is detected as crossing the specified border to enter into the specified location, the entry actions instructions for one or more specified operational adjustment rules 358 may be executed. Subsequently, when the device 105 is detected as crossing the specified border to exit the specified location, the exit instructions for one or more specified operational adjustment rules 358 may be executed. Thus, the device 105 may automatically initiate, or be caused to initiate, a security mode when the device 105 is either located within proximity to an insecure and/or sensitive location or is anticipated to enter proximity to an insecure and/or sensitive location. Conversely, the device 105 may automatically terminate, or be caused to terminate, a security mode when the device 105 is detected as no longer being located within proximity to an insecure and/or sensitive location. These and other multi-modal transition features are disclosed further herein.

Thus, in example operations, one or more processing device (e.g., of the mobile device 105 and/or of the system 102) may determine a location of the mobile device 105 associated with a particular endpoint 104. That location may correspond with current location of the mobile device 105. Such determination of location may be performed as disclosed herein, for example, via the GPS features of the device 105, cellular tower triangulation, Wi-Fi access point location determination, communications with one or more data source systems, and/or the like. The one or more processing devices may access a protocol record stored in a memory device and mapped to the endpoint 104. For example, the protocol record may, in some embodiments, be stored in memory of the device 105. In some embodiments, the protocol record may be stored alternatively or additionally in the data storage of the infrastructure system 102. In some embodiments, the mobile device 105 may request protocol record from the system 102, which may transmit the protocol record to the device 105 for the device 105 to process and use. In some embodiments, the mobile device 105 may receive one or more portions from the protocol record that is stored by the system 102, without having received the entire protocol record. In such embodiments, the system 102 may communicate the one or more portions from the protocol record to the device 105. In various embodiments, the system 102 may transmit instructions for one or more operational adjustments 382 to the device 105 to cause the device 105 to make or perform the one or more operational adjustments 382 in accordance with the instructions, with or without transmitting one or more portions of the protocol record.

The one or more processing devices may identify a particular set of one or more rules 358 specified by the protocol record. The particular set of one or more rules 358 may include criteria for identifying operational adjustment rules 358 from a plurality of operational adjustment rules 358 mapped to locations. The one or more processing devices may use the criteria to identify an operational adjustment rule from the plurality of operational adjustment rules 358. The operational adjustment rule may be identified at least partially as a function of the detected current location of the mobile device 105.

In various embodiments, one or a combination of the above operations may be performed consequent to the one or more processing devices detecting a communication received by the mobile device 105, the communication received via one or more wireless networks 120 from a device 107. Thus, some embodiments may react to communications received by the device 105 in real-time or near real-time with such operations directed to the adaptive data security and operation control. However, in some embodiments, one or a combination of the above operations may be performed prior to any such detecting of a communication.

In various embodiments, responsive to the device 105 receiving a communication or prior to such reception, the one or more processing devices may cause one or more operational adjustments 382 to the mobile device 105 in accordance with the operational adjustment rule. In various embodiments, the one or more operational adjustments 382 may include controlling whether to render one or more content objects on a screen of the mobile device 105 in response to the mobile device 105 receiving the communication and/or to perform one or more shunting and/or other preemptive operations in response to the mobile device 105 receiving the communication.

The operational adjustment rules 358 may provide for a multiplicity of operational adjustments 382 that may be a function of one or combination of the current location of the device 105 at a particular time, an anticipated location of the device 105 at a particular time, the particular communication source 106, the means of communication via an interface 107 and/or interface 105, the type of application being used by an endpoint 104, the content of the communication, the content being surfaced via an application of the endpoint device 105, and/or the like. The subsystem 300 may recognize any such communications, content associated with such communications, content associated with the application of the endpoint device 105, the use of the application of the endpoint device 105, and/or the like as being confidential and, hence, inappropriate for an insecure and/or sensitive location. Additionally or alternatively, the operational adjustment rules 358 may provide for a multiplicity of operational adjustments 382 that may be a function of one or combination of the current location of the device 105 at a particular time, an anticipated location of the device 105 at a particular time, the particular phenomena sensed at the device 105, the type of application being used by an endpoint 104, the content being surfaced via an application of the endpoint device 105, and/or the like. In various embodiments disclosed herein, the subsystem 300 may collect observation data regarding the above aspects and learn patterns as disclosed herein, which may be mapped to any specifications. Thus, as disclosed herein, responsive to detection of a communication from a source 106 or responsive to detection of phenomena at the device 105, the subsystem 300 may recognize the source 106 or phenomena as corresponding to a digital identifier (e.g., any suitable identifier of the source 106 or an individual sensed with the detected phenomena stored with protocol records of the subsystem 300). In various embodiments, the digital identifier may correspond to one or a combination of a phone number, a contact name or a name otherwise associated with the communication, an email address, an IP address, and/or the like that subsystem 300 determines as corresponding to the communication and a particular interface 107 and/or a particular communication source 106. In various embodiments, the digital identifier may correspond to one or a combination of a facial image or other image recognition corresponding to individual (e.g., recognition of the direction of gaze directed to the device 105), a thermal image (which, likewise may correspond recognition of an individual and/or recognition of a gaze directed toward the device 106), a voice print, other sound data corresponding to an individual, other sensor data that the subsystem 300 recognizes as indicia of someone potentially screen watching the device 106, and/or the like.

In some instances, the individual may not be recognized and, therefore, the digital identifier may correspond to an identified entity. The digital identifier may be mapped to an entity specification corresponding to the identified or unidentified source/individual. The entity specification may be stored with the protocol record in some embodiments. Responsive to the mapping of the digital identifier to the entity specification, the subsystem 300 may determine one or more rules 358 based at least in part on the protocol record, the currently detected location of the device 105, and/or the particularized pattern attributed to endpoint device 105. The one or more rules 358 may include specifications to anticipate one or more operational adjustments 382 based at least in part on a the currently detected location, movement of the device 105 in temporal proximity to the triggering event of the detection of the communication or phenomena, and the particularized pattern. Accordingly, some embodiments may anticipate going to a location and preemptively apply one or more operational adjustments 382 based on the learned pattern of operations associated with the location and/or transitions from a first location to a second location. Likewise, some embodiments may preemptively apply one or more operational adjustments 382 based on the learned pattern of operations associated with the time. Thus, one or combination of the operational adjustments 382 disclosed herein may be preemptively applied based at least in part on learned patterns as disclosed herein.

In some embodiments, the determining of a particularized pattern attributed to the identified endpoint 104 may include any one or combination of the following. A first subset of the first sensor data 304 may be received from at least one sensor of the set of one or more sensors 254. Based at least in part on the first subset of the first sensor data 304, a first movement of the identified endpoint 104 with respect to a reference location during a first time period may be identified. A first operational state change of the mobile device 105, within the first time period caused by the identified endpoint 104, consequent to the first movement may be identified. The first movement of the identified endpoint 104 with respect to a reference location may be correlated to the first operational state change of the mobile device 105. A second subset of the first sensor data 304 may be received from at least one sensor of the set of one or more sensors 254. Based at least in part on the second subset of the first sensor data 304, a second movement of the identified endpoint 104 with respect to the reference location during a second time period may be identified. A second operational state change of the mobile device 105 caused by the identified endpoint 104, within the second time period, consequent to the second movement may be identified. The second movement of the identified endpoint 104 with respect to the reference location may be correlated to the second operational state change of the mobile device 105. The first movement, the first time period, and the first operational state change of the mobile device 105 may be determined match the second movement, the second time period, and the second operational state change of the mobile device 105 based at least in part on a matching threshold being satisfied. Consequent to the determined match, the rule 358 may be derived, where the rule 358 includes associating a trigger for the operational setting of the mobile device 105 with movement criteria and time criteria corresponding to the first movement, the first time period, the first operational state change of the mobile device 105, the second time period, and the second operational state change of the mobile device 105.

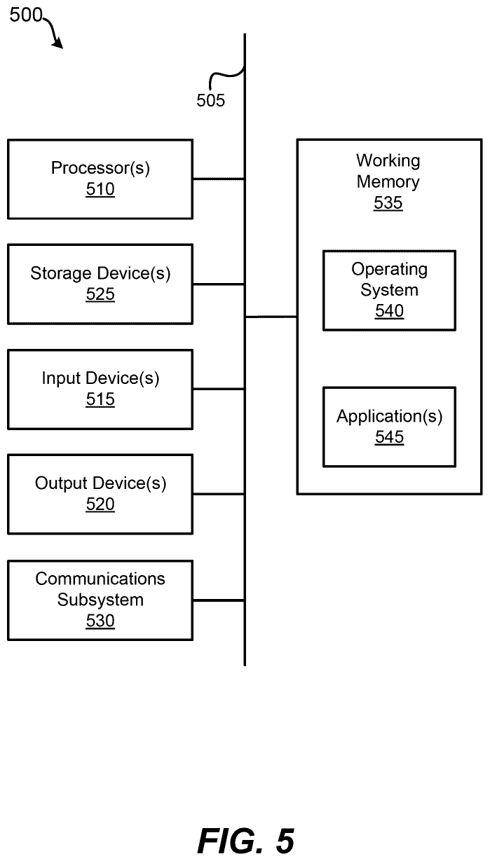

A computer system as illustrated in FIG. 5 may be incorporated as part of the previously described computerized devices. FIG. 5 provides a schematic illustration of one embodiment of a computer system 500 that can perform various steps of the methods provided by various embodiments. It should be noted that FIG. 5 is meant only to provide a generalized illustration of various components, any or all of which may be utilized as appropriate. FIG. 5, therefore, broadly illustrates how individual system elements may be implemented in a relatively separated or relatively more integrated manner.

The computer system 500 is shown comprising hardware elements that can be electrically coupled via a bus 505 (or may otherwise be in communication, as appropriate). The hardware elements may include one or more processors 510, including without limitation one or more general-purpose processors and/or one or more special-purpose processors (such as digital signal processing chips, graphics acceleration processors, video decoders, and/or the like); one or more input devices 515, which can include without limitation a mouse, a keyboard, remote control, and/or the like; and one or more output devices 520, which can include without limitation a display device, a printer, and/or the like.

The computer system 500 may further include (and/or be in communication with) one or more non-transitory storage devices 525, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable and/or the like. Such storage devices may be configured to implement any appropriate data storages, including without limitation, various file systems, database structures, and/or the like.

The computer system 500 might also include a communications subsystem 530, which can include without limitation a modem, a network card (wireless or wired), an infrared communication device, a wireless communication device, and/or a chipset (such as a Bluetooth™ device, an 802.11 device, a Wi-Fi device, a WiMAX device, cellular communication device, etc.), and/or the like. The communications subsystem 530 may permit data to be exchanged with a network (such as the network described below, to name one example), other computer systems, and/or any other devices described herein. In many embodiments, the computer system 500 will further comprise a working memory 535, which can include a RAM or ROM device, as described above.

The computer system 500 also can comprise software elements, shown as being currently located within the working memory 535, including an operating system 540, device drivers, executable libraries, and/or other code, such as one or more application programs 545, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the non-transitory storage device(s) 525 described above. In some cases, the storage medium might be incorporated within a computer system, such as computer system 500. In other embodiments, the storage medium might be separate from a computer system (e.g., a removable medium, such as a compact disc), and/or provided in an installation package, such that the storage medium can be used to program, configure, and/or adapt a general purpose computer with the instructions/code stored thereon. These instructions might take the form of executable code, which is executable by the computer system 500 and/or might take the form of source and/or installable code, which, upon compilation and/or installation on the computer system 500 (e.g., using any of a variety of generally available compilers, installation programs, compression/decompression utilities, etc.), then takes the form of executable code.

As mentioned above, in one aspect, some embodiments may employ a computer system (such as the computer system 500) to perform methods in accordance with various embodiments of the invention. According to a set of embodiments, some or all of the procedures of such methods are performed by the computer system 500 in response to processor 510 executing one or more sequences of one or more instructions (which might be incorporated into the operating system 540 and/or other code, such as an application program 545) contained in the working memory 535. Such instructions may be read into the working memory 535 from another computer-readable medium, such as one or more of the non-transitory storage device(s) 525. Merely by way of example, execution of the sequences of instructions contained in the working memory 535 might cause the processor(s) 510 to perform one or more procedures of the methods described herein.

The terms “machine-readable medium,” “machine-readable media,” “computer-readable storage medium,” “computer-readable storage media,” “computer-readable medium,” “computer-readable media,” “processor-readable medium,” “processor-readable media,” and/or like terms as used herein, refer to any medium that participates in providing data that causes a machine to operate in a specific fashion. These mediums may be non-transitory. In an embodiment implemented using the computer system 500, various computer-readable media might be involved in providing instructions/code to processor(s) 510 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the non-transitory storage device(s) 525. Volatile media include, without limitation, dynamic memory, such as the working memory 535.

Common forms of physical and/or tangible computer-readable media include, for example, a floppy disk, a flexible disk, hard disk, magnetic tape, or any other magnetic medium, a CD-ROM, any other optical medium, any other physical medium with patterns of marks, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 500.

The communications subsystem 530 (and/or components thereof) generally will receive signals, and the bus 505 then might carry the signals (and/or the data, instructions, etc. carried by the signals) to the working memory 535, from which the processor(s) 510 retrieves and executes the instructions. The instructions received by the working memory 535 may optionally be stored on a non-transitory storage device 525 either before or after execution by the processor(s) 510.

It should further be understood that the components of computer system 500 can be distributed across a network. For example, some processing may be performed in one location using a first processor while other processing may be performed by another processor remote from the first processor. Other components of computer system 500 may be similarly distributed. As such, computer system 500 may be interpreted as a distributed computing system that performs processing in multiple locations. In some instances, computer system 500 may be interpreted as a single computing device, such as a distinct laptop, desktop computer, or the like, depending on the context.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules 358 may take precedence over or otherwise modify the application of the invention. Also, a number of steps may be undertaken before, during, or after the above elements are considered.

Furthermore, the example embodiments described herein may be implemented as logical operations in a computing device in a networked computing system environment. The logical operations may be implemented as: (i) a sequence of computer implemented instructions, steps, or program modules running on a computing device; and (ii) interconnected logic or hardware modules running within a computing device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Also, the terms in the claims have their plain, ordinary meaning unless otherwise explicitly and clearly defined by the patentee. The indefinite articles “a” or “an,” as used in the claims, are defined herein to mean one or more than one of the element that the particular article introduces; and subsequent use of the definite article “the” is not intended to negate that meaning. Furthermore, the use of ordinal number terms, such as “first,” “second,” etc., to clarify different elements in the claims is not intended to impart a particular position in a series, or any other sequential character or order, to the elements to which the ordinal number terms have been applied.

What is claimed:

1. A system to facilitate adaptive control of operations of a mobile device, the system comprising:
one or more processing devices; and
memory communicatively coupled with and readable by the one or more processing devices and having stored therein processor-readable instructions which, when executed by the one or more processing devices, cause the one or more processing devices to perform operations comprising:
detecting a communication received by a mobile device, the communication received via one or more networks;
determining a location of a mobile device associated with an identified individual;
accessing a protocol record stored in a memory device;
identifying a set of one or more rules specified by the protocol record, where at least one operational adjustment rule of the set of one or more rules is mapped to one or more locations and comprises criteria for identifying one or more operational adjustments from a plurality of operational adjustments;
using the criteria to identify the one or more operational adjustments from the plurality of operational adjustments, where the one or more operational adjustments are identified at least partially as a function of the location of the mobile device; and
responsive to the detecting the communication, causing the one or more operational adjustments to the mobile device in accordance with the at least one operational adjustment rule, where:
the one or more operational adjustments comprise controlling whether to render one or more content objects on a screen of the mobile device in response to the mobile device receiving the communication and/or to perform one or more preemptive operations in response to the mobile device receiving the communication; and
the mobile device consequently renders the one or more content objects on the screen of the mobile device and/or performs the one or more preemptive operations.

2. The system to facilitate adaptive control of operations of a mobile device as recited in claim 1, the operations further comprising:
detecting a digital identifier corresponding to the communication, where the digital identifier corresponding to an entity specification mapped to the communication.

3. The system to facilitate adaptive control of operations of a mobile device as recited in claim 2, where the operational adjustment rule identified is partially as a function of one or both of the digital identifier and the entity specification.

4. The system to facilitate adaptive control of operations of a mobile device as recited in claim 2, the operations further comprising:
monitoring data received by the mobile device;
based at least in part on the monitoring, detecting the digital identifier corresponding to the communication.

5. The system to facilitate adaptive control of operations of a mobile device as recited in claim 2, the operations further comprising:
accessing a second set of one or more rules specified by the protocol record stored in the memory device, the second set of one or more rules comprising second criteria for recognizing entities; and
using the second criteria to analyze the digital identifier to map the digital identifier to the entity specification.

6. The system to facilitate adaptive control of operations of a mobile device as recited in claim 5, the operations further comprising:
collecting a set of observation data corresponding to one or more operations of the mobile device in one or more locations corresponding to the location.

7. The system to facilitate adaptive control of operations of a mobile device as recited in claim 6, the operations further comprising:
determining a particularized pattern of operations of the mobile device based at least in part on analyzing the set of observation data to correlate the one or more operations of the mobile device, the one or more locations, and one or more corresponding times;
where the operational adjustment rule is learned by the one or more processing devices based at least in part on the particularized pattern of operations of the mobile device.

8. A method to facilitate adaptive control of operations of a mobile device, the method comprising:
detecting, by one or more processing devices, a communication received by a mobile device, the communication received via one or more networks;
determining, by the one or more processing devices, a location of a mobile device associated with an identified individual;
accessing, by the one or more processing devices, a protocol record stored in a memory device;
identifying, by the one or more processing devices, a set of one or more rules specified by the protocol record, where at least one operational adjustment rule of the set of one or more rules is mapped to one or more locations and comprises criteria for identifying one or more operational adjustments from a plurality of operational adjustments;
using, by the one or more processing devices, the criteria to identify the one or more operational adjustments from the plurality of operational adjustments, where the one or more operational adjustments are identified at least partially as a function of the location of the mobile device; and
responsive to the detecting the communication, causing, by the one or more processing devices, the one or more operational adjustments to the mobile device in accordance with the at least one operational adjustment rule, where:
the one or more operational adjustments comprise controlling whether to render one or more content objects on a screen of the mobile device in response to the mobile device receiving the communication and/or to perform one or more preemptive operations in response to the mobile device receiving the communication; and
the mobile device consequently renders the one or more content objects on the screen of the mobile device and/or performs the one or more preemptive operations.

9. The method to facilitate adaptive control of operations of a mobile device as recited in claim 8, the method further comprising:
detecting, by the one or more processing devices, a digital identifier corresponding to the communication, where the digital identifier corresponding to an entity specification mapped to the communication.

10. The method to facilitate adaptive control of operations of a mobile device as recited in claim 9, where the operational adjustment rule identified is partially as a function of one or both of the digital identifier and the entity specification.

11. The method to facilitate adaptive control of operations of a mobile device as recited in claim 9, the method further comprising:
monitoring, by the one or more processing devices, data received by the mobile device;
based at least in part on the monitoring, detecting, by the one or more processing devices, the digital identifier corresponding to the communication.

12. The method to facilitate adaptive control of operations of a mobile device as recited in claim 9, the method further comprising:
accessing a second set of one or more rules specified by the protocol record stored in the memory device, the second set of one or more rules comprising second criteria for recognizing entities; and
using, by the one or more processing devices, the second criteria to analyze the digital identifier to map the digital identifier to the entity specification.

13. The method to facilitate adaptive control of operations of a mobile device as recited in claim 12, the method further comprising:
collecting, by the one or more processing devices, a set of observation data corresponding to one or more operations of the mobile device in one or more locations corresponding to the location.

14. The method to facilitate adaptive control of operations of a mobile device as recited in claim 13, the method further comprising:
determining, by the one or more processing devices, a particularized pattern of operations of the mobile device based at least in part on analyzing the set of observation data to correlate the one or more operations of the mobile device, the one or more locations, and one or more corresponding times;
where the operational adjustment rule is learned by the one or more processing devices based at least in part on the particularized pattern of operations of the mobile device.

15. One or more non-transitory, machine-readable media having machine-readable instructions thereon which, when executed by one or more processing devices, cause the one or more processing devices to perform operations comprising:
detecting a communication received by a mobile device, the communication received via one or more networks;
determining a location of a mobile device associated with an identified individual;
accessing a protocol record stored in a memory device;
identifying a set of one or more rules specified by the protocol record, where at least one operational adjustment rule of the set of one or more rules is mapped to one or more locations and comprises criteria for identifying one or more operational adjustments from a plurality of operational adjustments;
using the criteria to identify the one or more operational adjustments from the plurality of operational adjustments, where the one or more operational adjustments are identified at least partially as a function of the location of the mobile device; and
responsive to the detecting the communication, causing the one or more operational adjustments to the mobile device in accordance with the at least one operational adjustment rule, where:
the one or more operational adjustments comprise controlling whether to render one or more content objects on a screen of the mobile device in response to the mobile device receiving the communication and/or to perform one or more preemptive operations in response to the mobile device receiving the communication; and
the mobile device consequently renders the one or more content objects on the screen of the mobile device and/or performs the one or more preemptive operations.

16. The one or more non-transitory, machine-readable media as recited in claim 15, the operations further comprising:
detecting a digital identifier corresponding to the communication, where the digital identifier corresponding to an entity specification mapped to the communication.

17. The one or more non-transitory, machine-readable media as recited in claim 16, where the operational adjustment rule identified is partially as a function of one or both of the digital identifier and the entity specification.

18. The one or more non-transitory, machine-readable media as recited in claim 16, the operations further comprising:
monitoring data received by the mobile device;
based at least in part on the monitoring, detecting the digital identifier corresponding to the communication.

19. The one or more non-transitory, machine-readable media as recited in claim 16, the operations further comprising:
accessing a second set of one or more rules specified by the protocol record stored in the memory device, the second set of one or more rules comprising second criteria for recognizing entities; and
using the second criteria to analyze the digital identifier to map the digital identifier to the entity specification.

20. The one or more non-transitory, machine-readable media as recited in claim 19, the operations further comprising:
collecting a set of observation data corresponding to one or more operations of the mobile device in one or more locations corresponding to the location.
